(19) United States
(12) Patent Application Publication
(10) Pub. No.: US 2024/0023198 A1
(43) Pub. Date: Jan. 18, 2024

(54) BASE STATION AND METHOD PERFORMED BY THE SAME

(71) Applicant: Samsung Electronics Co., Ltd., Suwon-si (KR)

(72) Inventors: Hong WANG, Beijing (CN); Lixiang XU, Beijing (CN); Weiwei WANG, Beijing (CN)

(21) Appl. No.: 18/351,156

(22) Filed: Jul. 12, 2023

(30) Foreign Application Priority Data
Jul. 15, 2022 (CN) 202210836994.5
Mar. 22, 2023 (CN) 202310287002.2

(51) Int. Cl. H04W 76/40; H04W 4/06

(52) U.S. Cl. CPC H04W 76/40; H04W 4/06

(57) ABSTRACT

The disclosure relates to a 5G or 6G communication system for supporting a higher data transmission rate. The present disclosure may provide an apparatus and method. The method comprises: receiving a request message related to a MBS from a second CN, wherein the request message carries a second TMGI and/or indication information; sending a first response message to the second core network, wherein the indication information includes at least one of an MBS unique identifier, and a first TMGI; or wherein the second TMGI has partial fields the same as that of the first TMGI.

### CROSS-REFERENCE TO RELATED DISCLOSURE

This disclosure is based on and claims priority under 35 U.S.C. § 119 to Chinese Patent Application Nos. 202210836994.5, filed on Jul. 15, 2022, and 202310287002.2 filed on Mar. 22, 2023, in the CNIPA, the disclosure of which is incorporated by reference herein in its entirety.

### BACKGROUND

### 1. Field

The present disclosure relates to the technical field of wireless communication, and in particular to a base station and a method performed by the same.

### 2. Description of Related Art

In order to meet an increasing demand for wireless data communication services since a deployment of 4^{th} generation (4G) communication system, efforts have been made to develop an improved 5G or pre-5G communication system. Therefore, the 5G or pre-5G communication system is also called “beyond 4G network” or “post LTE system.”

Wireless communication is one of the most successful innovations in modern history. Recently, a number of subscribers of wireless communication services has exceeded 5 billion, and it continues growing rapidly. With the increasing popularity of smart phones and other mobile data devices (such as tablet computers, notebook computers, netbooks, e-book readers and machine-type devices) in consumers and enterprises, a demand for wireless data services is growing rapidly. In order to meet rapid growth of mobile data services and support new applications and deployments, it is very important to improve efficiency and coverage of wireless interfaces.

5G mobile communication technologies define broad frequency bands such that high transmission rates and new services are possible, and can be implemented not only in “Sub 6 GHz” bands such as 3.5 GHz, but also in “Above 6 GHz” bands referred to as mmWave including 28 GHz and 39 GHz. In addition, it has been considered to implement 6G mobile communication technologies (referred to as Beyond 5G systems) in terahertz bands (for example, 95 GHz to 3 THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced Mobile BroadBand (eMBB), Ultra Reliable Low Latency Communications (URLLC), and massive Machine-Type Communications (mMTC), there has been ongoing standardization regarding beamforming and massive MIMO for mitigating radio-wave path loss and increasing radio-wave transmission distances in mmWave, supporting numerologies (for example, operating multiple subcarrier spacings) for efficiently utilizing mmWave resources and dynamic operation of slot formats, initial access technologies for supporting multi-beam transmission and broadbands, definition and operation of BWP (BandWidth Part), new channel coding methods such as a LDPC (Low Density Parity Check) code for large amount of data transmission and a polar code for highly reliable transmission of control information, L2 pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as V2X (Vehicle-to-everything) for aiding driving determination by autonomous vehicles based on information regarding positions and states of vehicles transmitted by the vehicles and for enhancing user convenience, NR-U (New Radio Unlicensed) aimed at system operations conforming to various regulation-related requirements in unlicensed bands, NR UE Power Saving, Non-Terrestrial Network (NTN) which is UE-satellite direct communication for providing coverage in an area in which communication with terrestrial networks is unavailable, and positioning.

Moreover, there has been ongoing standardization in air interface architecture/protocol regarding technologies such as Industrial Internet of Things (IIoT) for supporting new services through interworking and convergence with other industries, IAB (Integrated Access and Backhaul) for providing a node for network service area expansion by supporting a wireless backhaul link and an access link in an integrated manner, mobility enhancement including conditional handover and DAPS (Dual Active Protocol Stack) handover, and two-step random access for simplifying random access procedures (2-step RACH for NR). There also has been ongoing standardization in system architecture/service regarding a 5G baseline architecture (for example, service based architecture or service based interface) for combining Network Functions Virtualization (NFV) and Software-Defined Networking (SDN) technologies, and Mobile Edge Computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with eXtended Reality (XR) for efficiently supporting AR (Augmented Reality), VR (Virtual Reality), MR (Mixed Reality) and the like, 5G performance improvement and complexity reduction by utilizing Artificial Intelligence (AI) and Machine Learning (ML), AI service support, metaverse service support, and drone communication.

Furthermore, such development of 5G mobile communication systems will serve as a basis for developing not only new waveforms for providing coverage in terahertz bands of 6G mobile communication technologies, multi-antenna transmission technologies such as Full Dimensional MIMO (FD-MIMO), array antennas and large-scale antennas, metamaterial-based lenses and antennas for improving coverage of terahertz band signals, high-dimensional space multiplexing technology using OAM (Orbital Angular Momentum), and RIS (Reconfigurable Intelligent Surface), but also full-duplex technology for increasing frequency efficiency of 6G mobile communication technologies and improving system networks, AI-based communication technology for implementing system optimization by utilizing satellites and AI (Artificial Intelligence) from the design stage and internalizing end-to-end AI support functions, and next-generation distributed computing technology for implementing services at levels of complexity exceeding the limit of UE operation capability by utilizing ultra-high-performance communication and computing resources.

The above information is presented as background information only to assist with an understanding of the disclosure. No determination has been made, and no assertion is made, as to whether any of the above might be applicable as prior art with regard to the disclosure.

### SUMMARY

The present disclosure provides a node and a method performed by the same that enable to increase wireless interface efficiency and to realize the enhancement of multicast and broadcast services MBSs. Technical solutions are as follows.

In a first aspect, there is provided a method performed by a first node in a wireless communication system, comprising:
receiving a request message related to a multicast and broadcast service MBS and sent from a second node, wherein the request message carries therewith a second TMGI and/or indication information;
sending a response message to the second node;
wherein the indication information comprises at least one of an MBS unique identifier, and a first TMGI.

In a possible implementation, if bearer of an MBS service to which the first TMGI corresponds has been established, bearer of an MBS service to which the second TMGI corresponds is not established, and the response message indicates a reason why the bearer of the MBS service to which the second TMGI corresponds is not established is that the first node is shared.

In another possible implementation, the response message carries therewith configuration information of PDCP used on the first node.

In the above embodiment of the present disclosure, the first node is at least one of a distributed unit DU, a central unit CU-control plane CP, a central unit CU-user plane UP, and a base station, and the second node is CU-CP and/or a core network entity.

In a second aspect, there is provided a method performed by a second node in a wireless communication system, comprising: sending a request message related to a multicast and broadcast service MBS to a first node, wherein the request message carries therewith a second TMGI and/or indication information; and receiving a response message sent by the first node, wherein the indication information includes at least one of an MBS unique identifier and the first TMGI.

In a possible implementation, if bearer of an MBS service to which the first TMGI corresponds has been established, bearer of an MBS service to which the second TMGI corresponds is not established, and the response message indicates a reason why the bearer of the MBS service to which the second TMGI corresponds is not established is that the first node is shared.

In another possible implementation, the response message carries therewith configuration information of PDCP used on the first node.

In the above embodiment of the present disclosure, the first node is at least one of a distributed unit DU, a central unit CU-control plane CP, a central unit CU-user plane UP, and a base station, and the second node is CU-CP and/or a core network entity.

In a third aspect, there is provided a node in a wireless communication system, comprising: a transceiver; and a controller, coupled with the transceiver and configured to perform operations corresponding to the method described in the first aspect of the present disclosure.

In this embodiment, the first node is at least one of a distributed unit DU, a central unit CU-control plane CP, a central unit CU-user plane UP, and a base station.

In a fourth aspect, there is provided a second node in a wireless communication system, comprising: a transceiver; and a controller, coupled with the transceiver and configured to perform operations corresponding to the method described in the second aspect of the present disclosure.

In this embodiment, the second node is CU-CP and/or a core network entity.

In a fifth aspect, there is provided a computer-readable storage medium, comprising a computer program stored thereon and is configured to implement, when executed by a processor, the method described in the first aspect or the second aspect of the present disclosure.

The technical solutions according to the present disclosure bring about the following beneficial effects: by carrying the second TMGI and/or indication information to which the second node corresponds in the request message related to the multicast broadcast service MBS, since the indication information includes at least one of an MBS unique identifier and a first TMGI, the wireless interface efficiency may be improved and the enhancement of the multicast and broadcast services MBS may be realized.

Before undertaking the DETAILED DESCRIPTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be included within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

In order to explain the technical solutions in the embodiments of the present disclosure more clearly, the drawings used in the description of the embodiments of the present disclosure will be briefly illustrated below.

FIG. 1 illustrates system architecture of system architecture evolution (SAE) according to an embodiment of the present disclosure;

FIG. 2 illustrates 5G initial overall architecture according to an embodiment of the present disclosure;

FIG. 3 illustrates a flowchart of a method performed by a first node in a wireless communication system according to an embodiment of the present disclosure;

FIG. 4 illustrates a flowchart of a method performed by a first node in a wireless communication system according to another embodiment of the present disclosure;

FIG. 5 illustrates a flowchart of a method performed by a first node in a wireless communication system according to another embodiment of the present disclosure;

FIG. 6 illustrates a method performed by a first node in a wireless communication system is applied in a start process of a broadcasting service of a non-separation architecture according to an embodiment of the present disclosure;

FIG. 7 illustrates a method performed by a first node in a wireless communication system is applied in a start process of a broadcasting service of a separation architecture according to an embodiment of the present disclosure;

FIG. 8 illustrates a method performed by a first node in a wireless communication system is applied in an activation process of a multicast service of a non-separation architecture according to an embodiment of the present disclosure;

FIG. 9 illustrates a method performed by a first node in a wireless communication system applied in an activation process of a multicast service of a separation architecture according to an embodiment of the present disclosure;

FIG. 10 illustrates a structure of a first node according to an embodiment of the present disclosure; and

FIG. 11 illustrates a method performed by a first node in a wireless communication system is applied in a start process of a broadcast service of a separation architecture according to an embodiment of the present disclosure.

### DETAILED DESCRIPTION

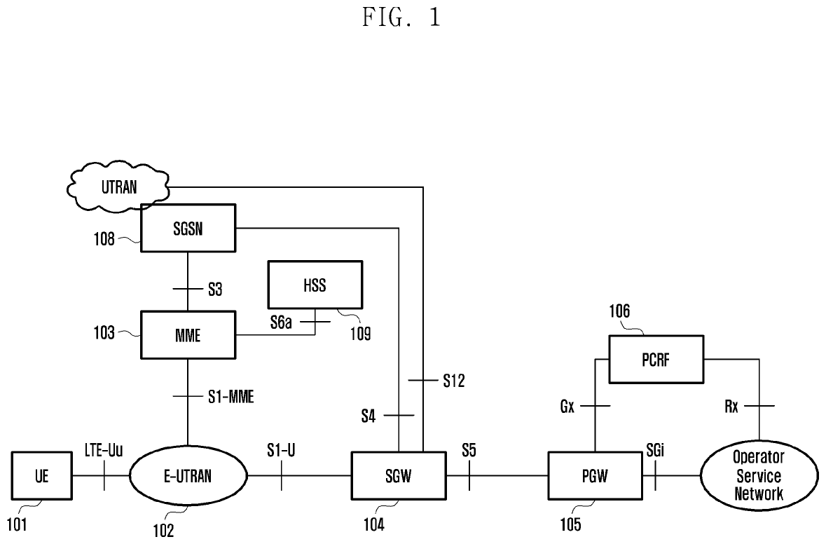

FIGS. 1 through 11, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

The following description with reference to the accompanying drawings is provided to assist in a comprehensive understanding of various embodiments of the present disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the present disclosure. In addition, descriptions of well-known functions and constructions may be omitted for clarity and conciseness.

The terms and words used in the following description and claims are not limited to the bibliographical meanings, but are merely used by the inventor to enable a clear and consistent understanding of the present disclosure. Accordingly, it should be apparent to those skilled in the art that the following description of various embodiments of the present disclosure is provided for illustration purpose only and not for the purpose of limiting the present disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

The term “include” or “may include” refers to the existence of a corresponding disclosed function, operation or component which can be used in various embodiments of the present disclosure and does not limit one or more additional functions, operations, or components. The terms such as “include” and/or “have” may be construed to denote a certain characteristic, number, step, operation, constituent element, component or a combination thereof, but may not be construed to exclude the existence of or a possibility of addition of one or more other characteristics, numbers, steps, operations, constituent elements, components or combinations thereof.

The term “or” used in various embodiments of the present disclosure includes any or all of combinations of listed words. For example, the expression “A or B” may include A, may include B, or may include both A and B.

Unless defined differently, all terms used herein, which include technical terminologies or scientific terminologies, have the same meaning as that understood by a person skilled in the art to which the present disclosure belongs. Such terms as those defined in a generally used dictionary are to be interpreted to have the meanings equal to the contextual meanings in the relevant field of art, and are not to be interpreted to have ideal or excessively formal meanings unless clearly defined in the present disclosure.

FIGS. 1 to 11 discussed below and various embodiments for describing the principles of the present disclosure in this patent document are only for illustration and should not be interpreted as limiting the scope of the disclosure in any way. Those skilled in the art will understand that the principles of the present disclosure can be implemented in any suitably arranged system or device.

FIG. 1 illustrates a system architecture 100 of system architecture evolution (SAE). User equipment (UE) 101 is a terminal device for receiving data. An evolved universal terrestrial radio access network (E-UTRAN) 102 is a radio access network, which includes a macro base station (eNodeB/NodeB) that provides UE with interfaces to access the radio network. A mobility management entity (MME) 103 is responsible for managing mobility context, session context and security information of the UE. A serving gateway (SGW) 104 mainly provides functions of user plane, and the MME 103 and the SGW 104 may be in the same physical entity. A packet data network gateway (PGW) 105 is responsible for functions of charging, lawful interception, etc., and may be in the same physical entity as the SGW 104. A policy and charging rules function entity (PCRF) 106 provides quality of service (QoS) policies and charging criteria. A general packet radio service support node (SGSN) 108 is a network node device that provides routing for data transmission in a universal mobile telecommunications system (UMTS). A home subscriber server (HSS) 109 is a home subsystem of the UE, and is responsible for protecting user information including a current location of the user equipment, an address of a serving node, user security information, and packet data context of the user equipment, etc.

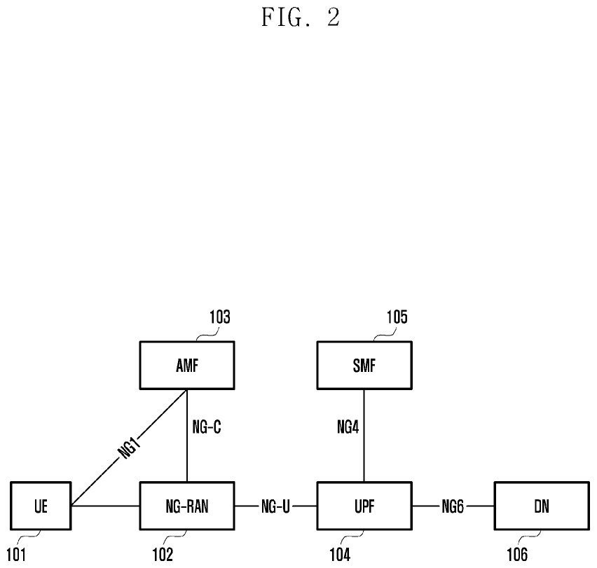

FIG. 2 illustrates a system architecture 200 according to various embodiments of the present disclosure. Other embodiments of the system architecture 200 can be used without departing from the scope of the present disclosure.

User equipment (UE) 201 is a terminal device for receiving data. A next generation radio access network (NG-RAN) 202 is a radio access network, which includes a base station (a gNB or an eNB connected to 5G core network 5GC, and the eNB connected to the 5GC is also called ng-gNB) that provides UE with interfaces to access the radio network. An access control and mobility management function entity (AMF) 203 is responsible for managing mobility context and security information of the UE. A user plane function entity (UPF) 204 mainly provides functions of user plane. A session management function entity SMF 205 is responsible for session management. A data network (DN) 206 includes, for example, services of operators, access of Internet and service of third parties. The interface between AMF and NG-RAN is called NG-C interface, or called NG interface, or called N2 interface. The interface between UPF and NG-RAN is called NG-U interface, or called N3 interface, and signaling between UE and AMF is called non-access layer signaling (NAS), and also called N1 interface. The interface between base stations is called Xn interface.

In order to effectively utilize air interface resources, for a service in which the same data is received by plural users, service data is provided to the users in the manners of broadcast and multicast. Such a service is referred to as a multicast and broadcast service (abbreviated as MBS).

MBS services are classified into two types, of which one is a multicast service, in which UEs may be firstly joined, subsequently when the multicast service starts, if the UEs are in a packet mobility management (PMM) idle mode, the network sends out a paging message, enabling the UEs to enter the PMM connection mode to receive service. Another one is a broadcast service, whereby it is not needed for the UEs to join in any packet, start information and configuration information of the service may be sent to the UEs in the manner of broadcast, and the data may be received in both of the PMM connection mode and the PMM idle mode.

When MBS is the broadcast service, the base station sends data to the UEs in the manner of broadcast, and the UEs in a radio resource control (RRC) idle, an RRC_inactive state and a connection mode can all receive data of the MBS service. When the base station has a separation architecture, relevant information of MBS is provided to a distributed unit (DU) by a central unit-control plane (CU-CP), and the DU generates an MBS control message, such as an MBS broadcast configuration message, and this message is sent to the UEs through an MB S-related common control channel, for example, sent to the UEs through a multimedia broadcast multicast service (MBMS) control channel (MCCH). For the multicast service, CU-CP sends relevant configuration information of MBS to the UEs through an RRC message, and only the UEs that are in the RRC connection mode can receive data of the multicast service of the MBS.

Under the deployment of access network sharing, the same and single MBS service is deployed by two (or more) operators respectively, and each of the operators assigns a different temporary mobile packet identifier (TMGI) to this MBS service. Under the current mechanism, the access network identifies MBS services through TMGIs, resource allocation is performed with respect to one TMGI, if TMGIs are different, the access network may assign different point-to-point resources to transmit the MBS data. However, the transmitted MBS data is actually directed to the same and single MBS service, while different resources are utilized to transmit the data, thus the resource utilization of the network is not so high, and an enhanced method is therefore required to improve the resource utilization.

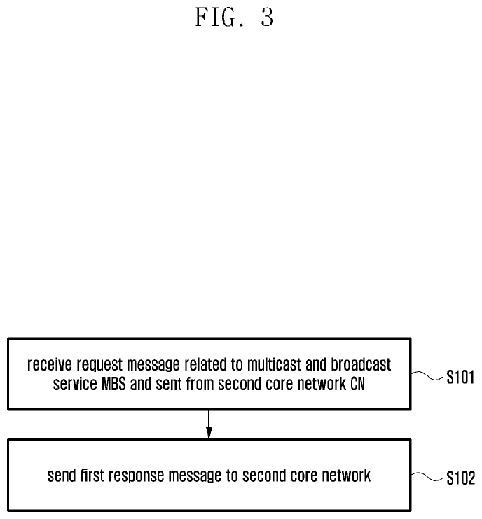

Accordingly, the present disclosure provides a method performed by a base station in a wireless communication system, as shown in FIG. 3, the method comprises:

S101—receiving a request message related to a multicast and broadcast service MBS and sent from a second core network CN, wherein the request message carries therewith a second TMGI and/or indication information; and

S102—sending a first response message to the second core network.

Wherein the indication information includes at least one of an MBS unique identifier, and a first TMGI; or, wherein the second TMGI has partial fields the same as that of the first TMGI.

In this embodiment, if the request message related to the multicast and broadcast service MBS received by the base station from the second CN can carry a second TMGI, the second TMGI has partial fields the same as that of the first TMGI. The second TMGI is assigned by the second CN for a requested second MBS service, and the first TMGI is assigned by a first CN for a requested first MBS service. Since the second TMGI has partial fields the same as that of the first TMGI, it is possible to determine that the second MBS service and the first MBS service pertain to the same and single MBS service, and the response message is sent to the second CN on the basis thereof.

If the request message related to the multicast and broadcast service MBS received by the base station from the second CN can carry indication information which includes at least one of the MBS unique identifier and the first TMGI. The first TMGI is assigned by the first CN for a requested first MBS service. It may be determined on the basis of at least one of the MBS unique identifier and the first TMGI that the second MBS service requested by the second CN and the first MBS service pertain to the same and single MBS service, and the response message is sent to the second CN on the basis thereof.

If the request message related to the multicast and broadcast service MBS received by the base station from the second CN can carry the second TMGI and the indication information, as may be known from the above description, it may be determined on the basis of this information that the second MBS service requested by the second CN and the first MBS service pertain to the same and single MBS service.

In the solution of the embodiment of the present disclosure, by carrying the second TMGI and/or the indication information corresponding to the second core network in the request message related to the multicast and broadcast service MBS, since the indication information includes at least one of the MBS unique identifier and the first TMGI, or since the second TMGI has partial fields the same as that of the first TMGI, wireless interface efficiency may be increased, and enhancement of the multicast and broadcast service MBS may be realized.

In some embodiments, if bearer of an MBS service to which the first TMGI corresponds has been established, the response message includes a transport layer address related to the bearer.

In the solution of the embodiment of the present disclosure, when a request message related to the multicast and broadcast service MBS and sent from a core network CN is received, it is determined on the basis of information carried in the request message that it is the same and single MBS service as the MBS service requested by another CN, and when bearer of the MBS service requested by another CN has been established, a transport layer address related to the established bearer may be carried in the response message sent to the CN, so that the broadcast and multicast service may be transmitted by sharing, the access network resource and air-interface resource may be saved, the utilization efficiency of resource accessed to the network and/or air-interface resource may be improved, and the effect of network nodes may be achieved.

In some other embodiments, the method may further comprise: sending an MBS broadcasting configuration message to a user equipment UE, wherein the MBS broadcasting configuration message includes the second TMGI and corresponding second related configuration information, and the first TMGI and corresponding first related configuration information; the first related configuration information and the second related configuration information are at least partially identical.

In this embodiment, the first related configuration information corresponding to the first TMGI carried in the MBS broadcasting configuration message as sent to the UE is at least partially identical with the second related configuration information corresponding to the second TMGI, and it can hence be determined on the basis of the same configuration information that the same air-interface resource is configured or schedule for the MBS service corresponding to the second TMGI and the MBS service corresponding to the first TMGI, thus the broadcast and multicast service may be transmitted by sharing, the access network resource and air-interface resource may be saved, the utilization efficiency of resource accessed to the network and/or air-interface resource may be improved, and the effect of network nodes may be achieved.

In another implementing solution of the above embodiment, the method as shown in FIG. 3 is performed by a centralized unit (CU)-control plane (CP) in a wireless communication system, in which case the method further comprises: sending an MBS-related bearer establishment request message to a central unit (CU)-user plane (UP), wherein the bearer establishment request message carries a second TMGI, an MBS radio bearer (MRB) identifier, and/or indication information, wherein the indication information includes at least one of an MBS unique identifier, and a first TMGI; wherein the second TMGI has partial fields the same as that of the first TMGI; or wherein the MRB identifier is identical with an MRB identifier of the first TMGI.

In this embodiment, the CU-CP may send an MBS-related bearer establishment request message to the CU-UP after receiving the request message related to the multicast and broadcast service MBS from the second CN, wherein, the bearer establishment request message can carry the second TMGI which has partial field identical with that of the first TMGI being, and/or, carry indication information that include at least one of the MBS unique identifier and the first TMGI, and/or, carry the MBS radio bearer MRB identifier, which is identical with the MRB identifier of the first TMGI. On the basis of the received request message, CU-UP can determine that the second MBS service requested by the second CN and the first MBS service pertain to the same and single MBS service, assign the same resource for the first MBS and the second MBS, and send the response message.

In some other embodiments, the method further comprises: sending an MBS-related MBS service context request message carrying therewith a first TMGI, a second TMGI and related information to a distributed unit DU, wherein the related information includes at least one of the following:
an MRG identifier assigned by a CU-control plane CP;
an MBS unique identifier; and
an MBS CU to DU RCC information list.

In this embodiment, the CU-CP can further send to the DU the MBS-related MBS service context establishment request message, wherein the MBS service context establishment request message can carry therewith the first TMGI, the second TMGI, and related information. Based on the received request message, the DU can determine that the second MBS service requested by the second CN and the first MBS service pertain to the same and single MBS service, assign the same resource for the first MBS service and the second MBS service, and send the response message.

In another implementing solution, the method further comprises: sending an MBS-related MBS service context request message carrying therewith the second TMGI and related information to a distributed unit DU, wherein the related information includes at least one of the following:
an MRB identifier assigned by the CU-CP;
an MBS unique identifier; and
MBS CU to DU RRC information, wherein the second TMGI has partial fields the same as that of the first TMGI.

In such embodiment, the CU-CP can further send to the DU an MBS-related MBS service context establishment request message, wherein the MBS service context establishment request message can carry therewith the second TMGI, which has partial field identical with that of the first TMGI, and related information. Based on the received request message, the DU can determine that the second MBS service requested by the second CN and the first MBS service pertain to the same and single MBS service, assign the same resource for the first MBS service and the second MBS service, and send the response message.

In some embodiments, the MBS radio bearer MRB identifier is identical with the MRB identifier of the first TMGI.

In some other embodiments, the MBS CU to DU RRC information is at least partially identical with MBS CU to DU RRC information of the first TMGI.

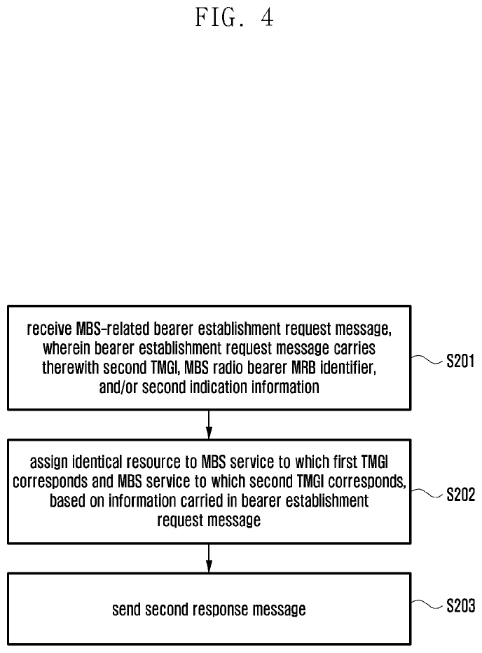

Based on the same inventive conception, an embodiment of the present disclosure further provides a method performed by a Central Unit CU-user plane UP in a wireless communication system, as shown in FIG. 4, the method comprises:

S201—receiving an MBS-related bearer establishment request message, wherein the bearer establishment request message carries therewith a second TMGI, an MBS radio bearer MRB identifier, and/or indication information;

S202—based on information carried in the bearer establishment request message, assigning same resource for an MBS service to which a first TMGI corresponds and an MBS service to which the second TMGI corresponds; and

S203—sending a second response message.

Wherein the indication information includes at least one of an MBS unique identifier, and the first TMGI; wherein the second TMGI has partial fields the same as that of the first TMGI; or wherein the MBS radio bearer MRB identifier is identical with an MRB identifier of the first TMGI.

According to the solution of the embodiment of the present disclosure, based on the second TMGI, the MBS radio bearer MRB identifier, and/or the indication information carried in the MB S-related bearer establishment request message, it may be determined that the second MBS service requested by the second CN and the first MBS service pertain to the same and single MBS service, since the indication information includes at least one of the MBS unique identifier and the first TMGI, or since the second TMGI has partial fields the same as that of the first TMGI, or since the MBS radio bearer MRB identifier is identical with the MRB identifier of the first TMGI, and the same resource is assigned to the MBS service corresponding to the first TMGI and the MBS service corresponding to the second TMGI, so as to transmit the broadcast and multicast service by sharing, thus access network resource and air-interface resource may be saved, the utilization efficiency of resource accessed to the network and/or air-interface resource may be improved, and the effect of network nodes may be achieved.

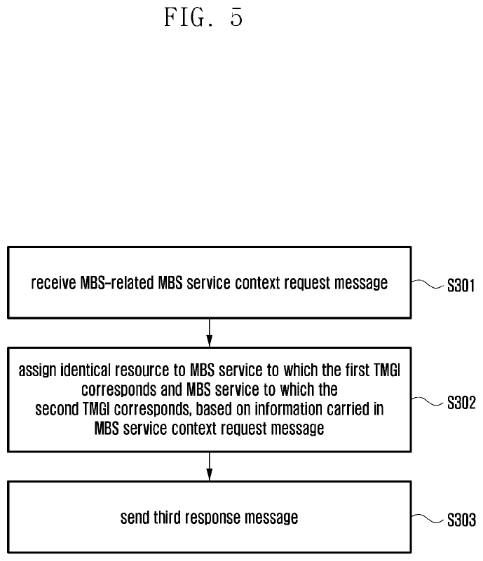

Based on the same inventive conception, an embodiment of the present disclosure further provides a method performed by a distributed unit DU in a wireless communication system, as shown in FIG. 5, the method comprises:

S301—receiving an MBS-related MBS service context request message carrying therewith a first TMGI, a second TMGI and related information;

S302—based on information carried in the MBS service context request message, assigning same resource to an MBS service to which the first TMGI corresponds and an MBS service to which the second TMGI corresponds, and

S303—sending a third response message.

Wherein the related information includes at least one of the following:
an MRB identifier assigned by a CU-CP;
an MBS unique identifier; and
an MBS CU to DU RCC information list.

According to the solution of the embodiment of the present disclosure, on the basis of the first TMGI, the second TMGI, and the related information carried in the MBS service context request message, it may be determined that the second MBS service requested by the second CN and the first MBS service pertain to the same and single MBS service, and the same resource is assigned to the MBS service corresponding to the first TMGI and the MBS service corresponding to the second TMGI, so that the broadcast and multicast service may be transmitted by sharing, thus the access network resource and air-interface resource may be saved, the utilization efficiency of resource accessed to the network and/or air-interface resource may be improved, and the effect of network nodes may be achieved.

Based on the same inventive conception, an embodiment of the present disclosure further provides a method performed by a distributed unit DU in a wireless communication system, as shown in FIG. 5, the method comprises:

S301—receiving an MBS-related MBS service context request message carrying therewith a first TMGI and related information;

S302—based on information carried in the MBS service context request message, assigning same resource to an MBS service to which the first TMGI corresponds and an MBS service to which a second TMGI corresponds, and

S303—sending a third response message.

Wherein the related information includes at least one of the following:
an MRB identifier assigned by a CU-CP;
an MBS unique identifier; and
MBS CU to DU RRC information, wherein the second TMGI has partial fields the same as that of the first TMGI.

According to the solution of the embodiment of the present disclosure, on the basis of the second TMGI and the related information carried in the MBS service context request message, wherein the second TMGI has partial fields the same as that of the first TMGI, it may be determined that the second MBS service requested by the second CN and the first MBS service pertain to the same and single MBS service, and the same resource is assigned to the MBS service corresponding to the first TMGI and the MBS service corresponding to the second TMGI, so that the broadcast and multicast service may be transmitted by sharing, thus the access network resource and air-interface resource may be saved, the utilization efficiency of resource accessed to the network and/or air-interface resource may be improved, and the effect of network nodes may be achieved.

In some embodiments, the MBS radio bearer MRB identifier is identical with an MRB identifier of the first TMGI.

In some other embodiments, the MBS CU to DU RRC information is at least partially identical with MBS CU to DU RRC information of the first TMGI.

The enhanced method according to the embodiments of the present disclosure is described below with an example in which an access network is shared by two operators, if the access network is shared by more than two operators, a similar method may also be employed.

The method according to the embodiments of the present disclosure is described in greater detail below with an example of an access network separation architecture. The CU-CP, the central unit-user plane (CU-UP) and the DU in the separation architecture are shared by two operators, both of which operate the same and single MBS service, and the operators assign different MBS identifiers TMGIs for the same and single MBS service, for example, operator 1 uses TMGI-1, and operator 2 uses TMGI-2. In order to send MBS service, an N3 channel between CU-UP and core network CN1 of the operator 1 and an N3 channel between CU-UP and core network CN2 of the operator 2 are respectively established, that is, two channels are established at the NG interface, and MBS data are received from core networks of the two operators through the two channels, respectively. One channel may be established between CU-UP and DU, i.e., one channel is established on F1 to transmit data of the MBS service. Alternatively, two channels are established to transmit MBS data of TMGI-1 and MBS data of TMGI-2, respectively.

CU-CP receives broadcast service start request messages from CN1 and CN2 respectively, or receives multicast service activation request messages from CN1 and CN2 respectively, the two messages include different MBS service identifiers TMGIs. According to the first indication information included in the message, CU-CP can know that the received messages belong to the same and single MBS service. The times at which CU-CP receives messages from CN1 and CN2 may be different. For the broadcast service, CU-CP may send one piece or two pieces of broadcast bearer establishment request(s) to CU-UP; for the multicast service, the CU-CP sends one piece or two pieces of multicast bearer establishment request(s) to the CU-UP, and the message carries therewith second indication information. For a broadcast service, CU-CP sends one piece or two pieces of broadcast context establishment request(s) to DU; for a multicast service, CU-CP sends one piece or two pieces of multicast context establishment request(s) to DU, and the message carries therewith third indication information.

CU-UP receives one piece or two pieces of broadcast bearer establishment request message(s), or CU-UP receives one piece or two pieces of multicast bearer establishment request message(s). If there is one message, the message includes two TMGIs, i.e., TMGI-1 and TMGI-2, the first TMGI is associated with the second TMGI, indicating the same and single MBS service, the message further includes one or two multicast radio bearer (MRB) identifier(s), and one message includes two TMGIs which are the second indication information, indicating that the services indicated by the two TMGIs are the same and single MBS service. If there are two messages, TMGIs carried in the two messages are different, and CU-UP is let to know through the same information that the two TMGIs are associated, and belong to the same service, i.e., the same information is the second indication information.

For example, when CU-CP receives two pieces of broadcast service start request messages, or two pieces of multicast service activation request messages, it is known that the two messages are directed to the same and single MBS service, CU-CP may assign the same MRB identifier which indicates that the two TMGIs are corresponding to the same and single MBS service. Alternatively, if there are two messages, it is further possible that TMGIs carried in the two messages are different, and that MRB identifiers are different; each message includes the associated TMGI except the first TMGI, both indicating the same and single MBS service.

CU-UP learns that the two TMGIs are directed to the same and single MBS service, and CU-UP assigns the same recourse for the two services, with the same PDCP configuration. According to the actually assigned resource and the pattern of the PDCP entity, the same resource and the same packet data convergence protocol (PDCP) configuration may be the same resource block and the same PDCP entity, respectively, during implementation. CU-UP assigns a data transport layer address to which one F 1 channel corresponds. Downlink data received by CU-UP from two N3 channels is processed through the same PDCP protocol, and CU-UP may determine, through a serial number included in a GTP-U header, whether the data received from the two channels are of the same IP packet. If the same data packet is received, CU-UP can discard one of them. For example, the data packet received later is discarded, and sent to DU through the F1 channel, by which time a channel is established between CU-UP and DU to transmit point-to-multipoint (PTM) data.

During implementation, the same resource and the same PDCP configuration may also be different resource blocks and different PDCP entities, but they have the same property and the same configuration, and CU-UP assigns data transport layer addresses to which two F1 channels correspond. The downlink data received by CU-UP from two N3 channels are sent to DU after being processed through different PDCP protocols, by which time two channels are established between CU-UP and DU to transmit PTM data.

On DU, DU receives one piece or two pieces of broadcast context establishment request message(s), or DU receives one piece or two pieces of multicast context establishment request message(s). If there is one message, the message includes two TMGIs, i.e., TMGI-1 and TMGI-2, the first TMGI is associated with the second TMGI, indicating the same and single MBS service, the message further includes one MRB identifier or two MRB identifiers. One message includes two TMGIs which are the third indication information, indicating that the services indicated by the two TMGIs are the same and single MBS service. If there are two messages, TMGIs carried in the two messages are different, and DU is let to know through the same information that the two TMGIs are associated, and belong to the same service, i.e., the same information is the second indication information. For example, as described above, MRB identifiers are the same, by carrying different TMGIs and the same MRB identifiers in two messages, it is indicated that the two TMGIs are directed to the same and single MBS service.

Alternatively, two messages carry different TMGIs and different MRB identifiers, each message includes the associated second TMGI except the first TMGI, both of which indicating the same and single MBS service. When DU learns that the two TMGIs are directed to the same service, DU assigns the same resource for the two services, the same configuration of radio link control (RLC) or media access control (MAC). According to the actually assigned resource and the pattern of the RLC entity or MAC entity, the same resource and the same RLC or MAC configuration may be the same resource block and the same RLC or MAC entity, respectively, during implementation. The same downlink reception data transport layer address is assigned by DU, and one F1 channel is established between CU-UP and DU. Downlink data received by DU from one F1 channel may be processed through the same RLC or MAC protocol, and then sent to UE, by which time one channel is established between CU-UP and DU to transmit PTM data.

In the case of the broadcast service, DU sends an MBS broadcast configuration message to UE. TMGI-1, TMGI-2 and their corresponding related configuration information may be broadcast by the MBS broadcast configuration message. The related configuration information includes a group radio network temporary identifier g-RNGI, and includes configuration of MRB, scheduling information of the MBS transport channel and configuration information of the physical channel. Although the related configuration information of TMGI-1 and the related configuration information of TMGI-2 are respectively broadcast, the two pieces of information may include the same group radio network temporary identifier, the same scheduling information of the MBS transport channel, and the same configuration information of the physical channel. That is, the MBS transport channel scheduling information and the configuration of the physical shared channel of the two services point to the same air-interface resource. Alternatively, group identifiers g-RNTIs are different, but the air-interface resource scheduled by the different g-RNTIs may be identical. In this way, the resources of the access network and air-interface may be greatly saved.

In the case of the multicast service, CU-UP sends an RRC reconfiguration request message which includes service identifier(s) TMGI-1 and/or TMGI-2 of MBS, identifier(s) of MRB(s) corresponding to TMGI-1 and/or TMGI-2, corresponding PDCP configuration, configuration information of RLC, configuration information of MAC, and configuration information of the physical layer, to which MRB corresponds. In order to support access network sharing, and to reduce wastage of air-interface resource, identifiers of MRBs to which service identifiers (for example, TMGI-1 and TMGI-2 in this embodiment) of a plurality of MBSs correspond are identical, then configurations of the MRBs are identical. That is, the corresponding PDCP configurations, RLC configurations, MAC configurations, and physical layer configurations are all identical, group identifiers g-RNTIs may also be identical, the physical layer resource used by them is the same, with the same block of resource, and resources assigned to TMGI-1 and TMGI-2 are scheduled through one group identifier. Alternatively, the group identifiers g-RNTIs are different, but the air-interface resource scheduled by different g-RNTIs may be the same.

The same resource and the same RLC or MAC configuration may also be different resource blocks, different RLC or MAC entities, respectively, during implementation, but has the same property and configuration. DU assigns two downlink data transport layer addresses to establish two F1 channels between DU and CU-UP. DU receives downlink data from the two F1 channels, one of which transmits data of the MBS service identified by TMGI-1, and another transmits data of the MBS service identified by TMGI-2, and DU knows that they pertain to the same and single MBS service. The data may be processed through different RLC or MAC protocols after being received by DU, and DU may send one piece of MBS data by scheduling the same block of air-interface resource.

In the case of the broadcast service, DU sends an MBS broadcast configuration message to UE in which related information of TMGI-1 and related information of TMGI-2 are respectively broadcast. The related information includes a group radio network temporary identifier (g-RNGI), and includes configuration of MRB, scheduling information of the MBS transport channel and configuration information of the physical channel. Although the related information of TMGI-1 and the related information of TMGI-2 are respectively broadcast, both of the information may include the same group radio network temporary identifier, the same scheduling information of the MBS transport channel, and the same configuration information of the physical channel. That is, the MBS transport channel scheduling information and the configuration of the physical shared channel of the two services may point to the same air-interface resource. Alternatively, group identifiers g-RNTIs are different, but the air-interface resource scheduled by different g-RNTIs may be identical. In this way, air-interface resource may be greatly saved.

In the case of the multicast service, CU-UP sends an RRC reconfiguration request message which includes service identifier(s) TMGI-1 and/or TMGI-2 of MBS, identifier(s) of MRB(s) corresponding to TMGI-1 and/or TMGI-2, corresponding PDCP configuration, configuration information of RLC, configuration information of MAC, and configuration information of the physical layer, to which MRB corresponds. In order to support access network sharing, and to reduce wastage of air-interface resource, identifiers of MRBs to which service identifiers (for example, TMGI-1 and TMGI-2 in this embodiment) of a plurality of MBSs correspond may be identical, and configurations of the MRBs may be identical. That is, the corresponding PDCP configurations, RLC configurations, MAC configurations, and physical layer configurations are all identical, group identifiers g-RNTIs may also be identical, the physical layer resource used by them is the same, with the same block of resource, and resources assigned to TMGI-1 and TMGI-2 are scheduled through one group identifier. Alternatively, the group identifiers g-RNTIs are different, but the air-interface resource scheduled by different g-RNTIs may be the same.

The method according to the embodiment of the present disclosure may also be applicable to the circumstance in which CU-UP is shared by two operators, while DU is not shared. In this case, channels are respectively established between CU-UP and two DUs. Only single piece of resource may be assigned on CU-UP.

The method according to the embodiment of the present disclosure may also be applicable to the circumstance in which DU is shared by two operators, while CU-UP is not shared. In this case, channels are respectively established between CU-UP and two DUs. DUs may assign the same resource, the same RLC or MAC configuration, and the same downlink data transport layer address for two services.

The method according to the embodiment of the present disclosure may also be applicable in the circumstance in which the access network is shared by a plurality of operators, in which case it is merely needed to adaptively amend the method.

Apparently, the embodiment of the present disclosure provides a method that supports network sharing for UE to receive MBSs, so that the broadcast and multicast services may be transmitted by sharing, resources of the access network and air-interface may be saved, the utilization efficiency of resource accessed to the network and/or air-interface resource may be improved, and the effect of network nodes may be achieved.

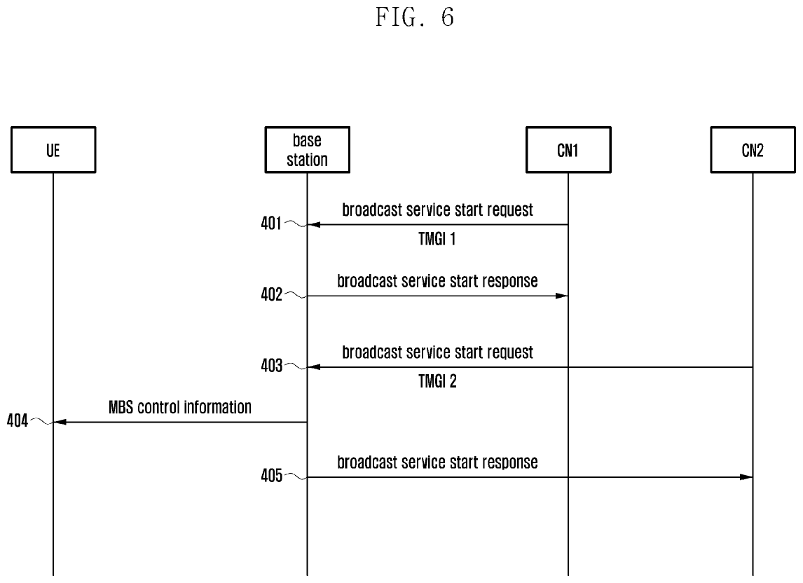

With reference to FIGS. 6 to 9 and FIG. 11, detailed description is made below with respect to the service start process of the broadcast service and the activation process of the multicast service.

FIG. 6 illustrates an embodiment process in which the method according to the embodiment of the present disclosure is applied in a service start process of a broadcast service. In this embodiment, the access network is shared by two operators, one MBS service is provided in the networks of the two operators, and MBS service identifiers respectively assigned by the two operators to the MBS service are TMGI-1 and TMGI-2.

In one example of Step 401, a base station receives a first broadcast service start request message sent from core network CN1.

Core network that belongs to operator 1 sends the first broadcast service start request message to the base station. The first broadcast service start request message includes a service identifier of the MBS, such as TMGI-1, the service range of the MBS, such as identifiers of a group of service areas (SAIs), or identifiers of a group of cells (such as CGIs), or identifiers of a group of routing areas (such as TAIs, or TACs), a transport layer address of an uplink user plane and/or a channel identifier. The message further includes information of MBS quality flow (QoS flow) to be established, such as an identifier of the QoS flow, QoS requirement of the QoS flow.

In one example of Step 402, the base station sends a first broadcast service start response message to CN1.

The base station sends the response message to CN1 which indicates that the MBS bearer and context of the TMGI-1 identifier have been successfully established.

In one example of Step 403, the base station receives a second broadcast service start request message sent from core network CN2.

Core network that belongs to operator 2 sends the second broadcast service start request message to the base station. The message in Step 401 includes TMGI-1, and the message in Step 403 includes TMGI-2. Reference may be made to the description in Step 401 for other contents of the message in Step 403, for the sake of brevity, no repetition is made here.

In order to save equipment investment of the operator, network sharing is a common deployment method. Network sharing means that the same access network equipment is used by a plurality of operators. An MBS service may be broadcast under the plurality of operators, different operators may assign different service identifiers TMGIs to the same and single MBS service. Currently, the access network identifies different services through TMGIs, once TMGIs are different, it is then considered that services are different. The access network assigns different access network resources and air-interface resources to transmit MBS data of actually the same service. In order to reduce resource consumption of the radio network and the air-interface, if one node supports a plurality of operators, the access network may assign the same network resource and air-interface resource for the same and single MBS service to transmit data received from different core networks and belonging to the same and single MBS service. For this purpose, any of the following Method 1 to Method 4 may be employed to indicate the base station that two messages are related to the same and single MBS service. The messages of step 403 and step 401 are related to the same and single MBS service, which is indicated through the carried indication information in Method 1 and Method 2, through partial fields of TMGI-1 and TMGI-2 being identical in Method 3, and through OAM configuration in Method 4. Specifically,

In one embodiment of Method 1, the message further carries an MBS unique service identifier (such as: MBS global identity).

The unique service identifier uniquely identifies one MBS service, and MBS service of the same type have the same and single MBS unique service identifier under different operator networks.

In one embodiment of Method 2, the message further carries TMGIs assigned to the MBS by other core networks operating the same and single MBS.

The same service has a corresponding service identifier TMGI under each operator. For example, in this embodiment, the same service has the service identifier TMGI-1 under operator 1 and the service identifier TMGI-2 under operator 2. When operator 1 sends the MBS service start request message, the message includes not only the service identifier TMGI-1 of the MBS service under operator 1, but also the service identifier TMGI-2 of the same and single MBS service under operator 2. TMGI-2 and TMGI-1 are associated, and point to the same and single MBS service.

In one embodiment of Method 3, partial fields in TMGI-2 and TMGI-1 identifiers are identical, for example, the MBS service identifiers (MBS service IDs) are identical.

The same service has a corresponding service identifier TMGI under each operator. For example, in this embodiment, the same service has the service identifier TMGI-1 under operator 1 and the service identifier TMGI-2 under operator 2. A TMGI includes two parts of contents, one of which is the operator identifier (including MCC and MNC), and another one is employed to identify the MBS service, and may be referred to as MBS Service ID. The same and single MBS Service ID and different operator identifiers may be used for the same service under different operators. The same and single MBS service can be identified by using the same and single MBS Service ID under different operators.

In one embodiment of Method 4, there is no newly added information to the message, through operation administration and maintenance (OAM) of the information pre-configured on the base station, the base station may learn that the aforementioned TMGI-1 and TMGI-2 belong to the same and single MBS service.

In one example of Step 404, the base station sends an MBS broadcast configuration message to UE.

The broadcast configuration message includes MBS broadcast configuration to which TMGI-1 corresponds and MBS broadcast configuration to which TMGI-2 corresponds. The broadcast configuration message is sent to UE through an MBS control channel, such as a multi cast control channel (MCCH). TMGI-1, TMGI-2 and their corresponding related configuration information may be respectively broadcast in the MBS broadcast configuration message of an air-interface, and the related configuration information includes group radio network temporary identifiers g-RNGIs, configurations of MRBs, scheduling information of MBS transport channels, and configuration information of physical channels. The configuration corresponding to TMGI-2 is at least partially identical with the configuration corresponding to TMGI-1.

The group radio network temporary identifiers corresponding to TMGI-1 and TMGI-2 may be identical, the scheduling information of the MBS transport channels may be identical, and the configuration information of the physical channels may be identical. In other words, such information as the group identifiers g-RNTIs, configurations of PDCP, configurations of RLC, configurations of DRX, adjacent area configurations, and configurations of PTM shared channels etc., to which different TMGIs correspond, may be identical with respect to the scenario of access network sharing. MBS transport channel scheduling information and configurations of physical shared channels of the two services point to the same block of air-interface resource. Alternatively, the group identifiers g-RNTIs are different, but air-interface resource scheduled by the different g-RNTIs may be identical.

The message in Step 404 may be sent after Step 402 or after Step 405.

In one example of Step 405, the base station sends a second broadcast service start response message to CN2.

The base station sends the response message to CN2, and the response message indicates that bearer and context of the MBS identified by TMGI-2 have been successfully established. The response message carries therewith an NG-U transport layer address which includes the IP address of the base station and the channel identifier assigned by the base station. The transport layer address may be identical with that assigned by the base station for TMGI-1.

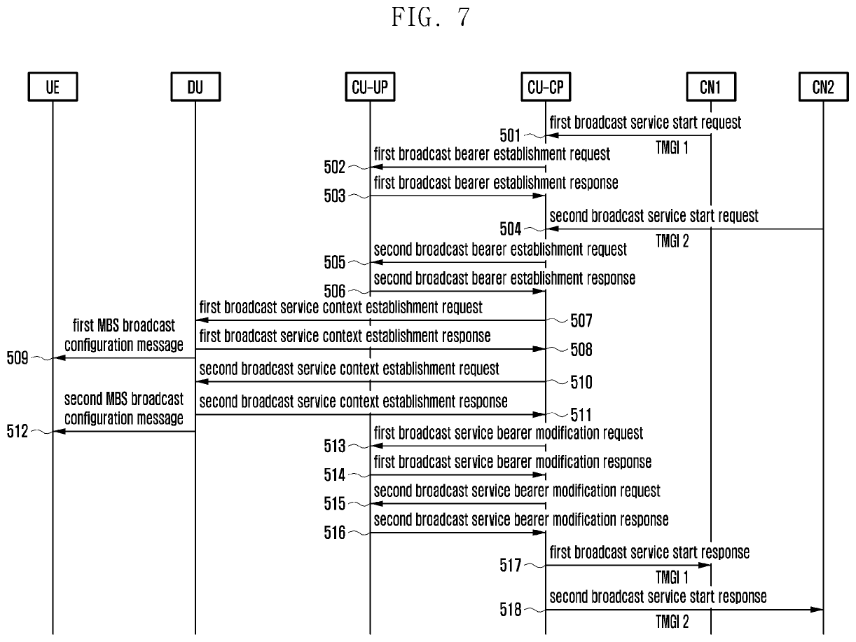

FIG. 7 illustrates an implementing process in which the method according to the embodiment of the present disclosure is applied in a service start process of a broadcast service. In this embodiment, the access network is shared by two operators, one MBS service is provided in the networks of the two operators, and MBS service identifiers respectively assigned by the two operators to the MBS service are TMGI-1 and TMGI-2.

In one example of Step 501, CU-CP receives a first broadcast service start request message sent from a core network.

The core network that belongs to operator 1 sends the first broadcast service start request message to CU-CP. The first broadcast service start request message includes a service identifier of the MBS, such as TMGI-1, the service range of the MBS, such as identifiers of a group of service areas (SAIs), or identifiers of a group of cells (such as CGIs), or identifiers of a group of routing areas (such as TAIs, or TACs), a transport layer address of an uplink user plane and/or a channel identifier. The message further includes information of MBS quality flow (QoS flow) to be established, such as an identifier of the QoS flow, QoS requirement of the QoS flow.

In one example of Step 502, CU-CP sends a first broadcast bearer establishment request message to CU-UP.

The message includes a broadcast service bearer context to be established, in which an MRB establishment list of the broadcast service is included. The MRB establishment list includes the identifier of MRB, an MRB-related MBS QoS flow list, and configuration information corresponding to MRB, etc.

In one example of Step 503, CU-UP sends a first broadcast bearer establishment response message to CU-CP.

The message includes the identifier of the successfully established MRB, and the successfully established MBS QoS flow list.

In one example of Step 504, CU-CP receives a second broadcast service start request message sent from a core network CN2.

The core network that belongs to operator 2 sends the first broadcast service start request message to CU-CP. The first broadcast service start request message includes a service identifier of the MBS, such as TMGI-2, the service range of the MBS, such as identifiers of a group of service areas (such as SAIs), or identifiers of a group of cells (such as CGIs), or identifiers of a group of routing areas (such as TAIs, or TACs), a transport layer address of an uplink user plane and/or a channel identifier. The message further includes information of MBS quality flow (QoS flow) to be established, such as the identifier of the QoS flow, QoS requirement of the QoS flow. In order to save equipment investment of the operator, network sharing is a common deployment method. Network sharing means that the same access network equipment is used by a plurality of operators.

An MBS service may be broadcast under the plurality of operators, different operators may assign different service identifiers TMGIs to the same and single MBS service. CU-CP may further receive the second broadcast service start request message of step 504 from another core network after receiving the message of step 501. The two messages are actually related to the same and single MBS service, since the TMGIs carried in the messages of step 501 and step 504 are different and currently the access network identifies different services through TMGIs, once TMGIs are different, it is then considered that services are different, and the access network assigns different access network resources and air-interface resources to transmit MBS data of actually the same service. In order to reduce resource consumption of the radio network and the air-interface, if one node supports a plurality of operators, the access network may assign the same network resource and air-interface resource for the same and single MBS service to transmit data received from different core networks and belonging to the same and single MBS service.

For this purpose, any of the following Method 1 to Method 4 may be employed to indicate CU-CP that two messages are related to the same and single MBS service. The messages of Step 403 Step 401 are related to the same and single MBS service, which is indicated through carried indication information in Method 1 and Method 2, through partial fields of TMGI-1 and TMGI-2 being identical in Method 3, and through OAM configuration in Method 4. Specifically, in one embodiment of Method 1, the message further carries an MBS unique service identifier (such as: MBS global identity).

The unique service identifier uniquely identifies one MBS service, and MBS services of the same type have the same and single MBS unique service identifier under different operator networks.

In one embodiment of Method 2, the message further carries TMGIs assigned to the MBS by other core networks operating the same and single MBS service.

The same service has a corresponding service identifier TMGI under each operator. For example, in this embodiment, the same service has the service identifier TMGI-1 under operator 1, and the service identifier TMGI-2 under operator 2. When operator 1 sends the MBS service start request message, the message includes not only the service identifier TMGI-1 of the MBS service under operator 1, but also the service identifier TMGI-2 of the same and single MBS service under operator 2. TMGI-2 and TMGI-1 are associated and pointing to the same and single MBS service.

In one embodiment of Method 3, partial fields in TMGI-2 and TMGI-1 identifiers are identical, for example, the MBS service identifiers (MBS Service IDs) are identical.

The same service has a corresponding service identifier TMGI under each operator. For example, in this embodiment, the same service has the service identifier TMGI-1 under operator 1 and the service identifier TMGI-2 under operator 2. A TMGI includes two parts of contents, one of which is the operator identifier (including MCC and MNC), and another one is employed to identify the MBS service, and may be referred to as MBS Service ID. The same and single MBS Service ID and different operator identifiers may be used for the same service under different operators. The same and single MBS service can be identified by using the same and single MBS Service ID under different operators.

In one embodiment of Method 4, there is no newly added information to the message, through operation administration and maintenance (OAM) of the information pre-configured on the base station, the base station may learn that the aforementioned TMGI-1 and TMGI-2 belong to the same and single MBS service.

In one example of Step 505, CU-CP sends a second broadcast bearer establishment request message to CU-UP.

During the process of establishing an interface between CU-CP and CU-UP, i.e., during the process of establishing a request from E1, CU-CP may obtain identifiers of operators supported by CU-UP, and learn that CU-UP is a node shared by a plurality of operators.

At previous steps, for example, step 501 to step 503, CU-CP has assigned an MRB bearer to the TMGI-1-related MBS service, and the bearer has been established on CU-UP. CU-CP may use this bearer to transmit data of TMGI-2, that is, to assign to TMGI-2 an MRB identifier and configuration information identical with that of TMGI-1, by which time it is not necessary to send the message of step 505. Alternatively, CU-CP assigns to TMGI-2 an MRB identifier identical with that of the bearer of TMGI-1, and sends the message of step 505 to CU-UP. Alternatively, CU-CP assigns to TMGI-2 an MRB identifier different from that of the bearer of TMGI-1, and sends the message of step 505. CU-UP assigns resource, which is at least partially identical with the resource assigned to TMGI-1, to TMGI-2, according to the same MRB identifier or indication information.

Specifically, in one embodiment of Method 1, CU-CP receives the first broadcast service start request message in Step 501, the message includes an MBS unique service identifier (such as MBS global identity) and the service identifier TMGI-1.

At the later Step 504, CU-CP receives the second broadcast service start request message from the core network CN2 of operator 2, the message includes an MBS unique service identifier (such as MBS global identity), and the second broadcast message further includes the service identifier TMGI-2. If the MBS unique service identifiers included in the first broadcast service start request and the second broadcast service start request are identical, CU-CP may learn that the MBS to which the two messages correspond is the same and single MBS service, and CU-CP assigns the same MRB identifier or different MRB identifiers to TMGI-2 and TMGI-1. CU-CP sends the second broadcast bearer establishment request message in step 505 to CU-UP, the message includes TMGI-2, and includes the MRB identifier and information of QoS flow. The message may further include an MBS unique service identifier (such as MBS global identity).

If the MRB identifier included in the second broadcast bearer establishment request message is the same as that included in the first broadcast bearer establishment request message, CU-UP may learn that the MBS services to be established by the two messages belong to the same service. If the MRB identifiers included in the two messages are different, and the two messages both include MBS unique service identifiers and the MBS unique service identifiers are identical, CU-UP may learn that the MBS services to be established by the two messages belong to the same service. CU-UP assigns the same resource to TMGI-1 and TMGI-2, that is, the same resource may be used by different MRBs.

When the second broadcast service start request message is received, it is also possible for CU-CP to learn, through the MBS unique service identifiers included in the second broadcast service start request and the first broadcast service start request being identical, that the bearer of the service has already been established at CU-UP, and CU-CP may not send the second broadcast bearer establishment request message in step 505. CU-CP may send to CN2 the NG-U transport layer address carried in the first broadcast bearer establishment response message received in step 503.

According to Method 2, CU-CP receives the first broadcast service start request message in step 501 which includes service identifier TMGI-1 of MBS at operator 1 and service identifier TMGI-2 of its associated operator 2, CU-CP may learn that TMGI-1 and TMGI-2 are directed to the same service, CU-CP assigns the MRB identifier to the MBS, and CU-CP sends to CU-UP the first broadcast bearer establishment request message in step 502. The message may include TMGI-1, and include the MRB identifier and information of QoS flow. The message may further include the associated TMGI-2.

At the later step 504, CU-CP receives the second broadcast service start request message from core network CN2 of operator 2 which includes TMGI-2 and TMGI-1. CU-CP may send the second broadcast bearer establishment request message in step 505 which includes service identifiers TMGI-1 and TMGI-2 of the MBS under operator 1 and operator 2. The MRB identifier included in the second broadcast bearer establishment request may be identical with that included in the first broadcast bearer establishment request message. Alternatively, CU-CP considers that the bearer of the MBS has been established on CU-UP, and does not send the second broadcast bearer establishment request message in step 505.

According to Method 3, CU-CP receives the message in step 501, i.e., the first broadcast service start request message, and the message includes service identifier TMGI-1 of MBS of operator 1. CU-CP sends to CU-UP the first broadcast bearer establishment request message of step 502, and the message may include TMGI-1, and include the MRG identifier and information of QoS flow.

Thereafter, at step 504, CU-CP receives the second broadcast service start request message sent from core network CN2 which includes TMGI-2. CU-CP may learn, through the identical MBS Service ID included in TMGI-1 and TMGI-2, that TMGI-1 and TMGI-2 actually belong to the same and single MBS service, and CU-CP may assign to TMGI-2 an MRB identifier that is identical with that of TMGI-1 or different from that of TMGI-1. CU-CP sends to CU-UP the second broadcast bearer establishment request message in step 505, and the message may include TMGI-2, and include the MRB identifier and information of QoS flow.

CU-UP receives the first broadcast bearer establishment request message and the second broadcast bearer establishment request message. If the MRB identifiers included in the two messages are identical, CU-UP may learn that the MBS services to be established by the two messages belong to the same service. If the MRB identifiers included in the two messages are different, and TMGI-1 and TMGI-2 included in the two messages have the same and single MBS Service ID, CU-UP may learn that the MBS services to be established by the two messages belong to the same service, and CU-UP assigns the same resource to TMGI-1 and TMGI-2.

According to Method 4, CU-CP receives the message of step 501, the first broadcast service start request message, and the message includes service identifier TMGI-1 of the MBS under operator 1. CU-CP sends to CU-UP the first broadcast bearer establishment request message of step 502, and the message may include TMGI-1, and include the MRB identifier and information of QoS flow.

Thereafter, at step 504, CU-CP receives the second broadcast service start request message sent from core network 2 which includes TMGI-2. CU-CP may learn from pre-configuration that TMGI-1 and TMGI-2 are directed to the same service, and CU-CP assigns identical MRB identifiers or different MRB identifiers to TMGI-1 and TMGI-2. The second broadcast service bearer establishment request message sent from CU-CP may include TMGI-2, and include the MRB identifier and information of QoS flow.

CU-UP receives the first broadcast bearer establishment request message and the second broadcast bearer establishment request message. If the MRB identifiers included in the two messages are identical, CU-UP may know that the MBS services to be established by the two messages belong to the same service. If the MRB identifiers included in the two messages are different, as the two messages respectively include TMGI-1 and TMGI-2, CU-UP knows through pre-configuration that TMGI-1 and TMGI-2 are directed to the same service. CU-UP assigns the same resource to TMGI-1 and TMGI-2, that is, the same resource may be used by different MRB s.

In one example of Step 506, CU-UP sends a second broadcast bearer establishment response message to CU-CP.

The message includes an identifier of the successfully established MRB, and successfully established MBS QoS flow list. As noted in step 505, step 506 may also be omitted.

In one example of Step 507, CU-CP sends a first broadcast service context establishment request message to DU.

The message includes a service identifier of the MBS, such as TMGI-1, the service range of the MBS, such as identifiers of a group of service areas (such as SAIs), or a group of cell identifiers (such as CGIs), or identifiers of a group of cells (such as TAIs, or TACs), and the message includes MBS CU to DU RRC information. The MBS CU to DU RRC information includes a list of cells to which the MBS broadcast and a list of adjacent cells that broadcast the MBS service, and the MBS CU to DU RRC information further includes MRB PDCP configuration. The broadcast service context establishment request message further includes information of the MBS radio bearer to be established, such as the identifier of MRB, quality requirement of MRB, the identifier of QoS flow mapped to the MRB, and QoS requirement of QoS flow. The broadcast is carried therewith the transport layer address of CU or CU-UP.

Under the scenario of access network sharing, the broadcast service context establishment request message may further contain:
an MBS unique service identifier (such as MBS global identity);
TMGI-2, the message may further include TMGI-2 besides TMGI-1, and TMGI-1 and TMGI-2 are associated, and point to the same and single MBS service;
MRB identifier, with respect to the shared access network, CU-CP assigns the same MRB identifier to TMGI-1 and TMGI-2;
MBS CU to DU RRC information list, the message includes a plurality of pieces of MBS CU to DU RRC information, the MBS CU to DU RRC information includes a list of adjacent areas broadcast the same and single MBS service, and PDCP configuration information to be sent to UE through control signaling of the MBS service. With respect to different operators, the same and single MBS uses different TMGIs under different operators. In order that all UEs can receive the MBS, MBS control signaling of an air-interface may include control signaling of TMGI-1 and control signaling of TMGI-2, the message in step 507 includes a plurality of pieces of MBS CU to DU RRC information, and each piece of the MBS CU to DU RRC information includes information to be sent via MBS control signaling under an operator; and
transport layer address(s) assigned by DU for MBS data reception, when the transport layer address(s) includes one transport layer address, a channel is established between CU-UP and DU for MBS services identified by TMGI-1 and TMGI-2, or when the transport layer address(s) include two transport layer addresses, channels are established between CU-UP and DU for MBSs identified by TMGI-1 and TMGI-2, respectively.

DU receives the message of step 507, and may learn that the same resource and the same RLC or MAC configuration being assigned for the MBS services identified by TMGI-1 and TMGI-2. CU-CP may only send one broadcast service context establishment request message to DU, and does not send the second broadcast service context establishment request message in step 510 to DU.

DU receives the first broadcast service context establishment request message in step 507. If the second broadcast service context establishment request message in step 510 is thereafter received, it is required for DU to learn from the information included in the two messages that the two messages are directed to the same and single MBS service, and the same resource may therefore be assigned. As described above, it may be known that TMGI-1 and TMGI-2 are directed to the same and single MBS service, through the same and single MBS unique service identifier, such as MBS global identity, or the same MRB identifier included in the first broadcast service context establishment request message and the second broadcast service context establishment request message, or through the same and single MBS Service ID included in the TMGI-1 and TMGI-2, or through pre-configuration on DU. DU assigns the same resource and the same RLC or MAC configuration to the MBS services identified by TMGI-1 and TMGI-2.

In one example of Step 508, DU sends a first broadcast service context establishment response message to CU-CP.

The message includes the successfully established MRB identifier, and includes F1-U transport layer information to which the broadcast bearer corresponds.

In one example of Step 509, DU sends a first MBS broadcast configuration message to UE.

The first MBS broadcast configuration message includes MBS broadcast configuration to which TMGI-1 corresponds, and the broadcast configuration is sent to UE through an MBS control channel, such as an MCCH channel. The first MBS broadcast configuration message includes TMGI-1 and corresponding MBS control information thereof. The control information includes related configuration information such as an identifier of TMGI, the group identifier g-RNTI of TMGI, the configuration of PDCP, the configuration of RLC, the configuration of DRX, the configuration of adjacent areas, and the configuration of the PTM shared channel. With respect to the scenario of the access network sharing, configurations of different TMGIs may be identical. For example, group identifiers of TMGI-1 and TMGI-2 may be identical, and the information such as the configurations of PDCP, the configurations of RLC, the configurations of DRX, the configurations of the adjacent areas, and the configurations of the PTM shared channels are identical. Alternatively, the group identifiers g-RNTIs are different, but air-interface resource scheduled by the different g-RNTIs may be identical.

In one example of Step 510, CU-CP sends a second broadcast service context establishment request message to DU.

This step may be omitted, i.e., the broadcast service contexts of TMGI-1 and TMGI-2 are established through one message. It is also possible to respectively establish channels of TMGI-1 and TMGI-2 on F1 with two messages.

In one example of Step 511, DU sends a second broadcast service context establishment response message to CU-CP.

The message includes the successfully established MRB identifier, and includes F1-U transport layer information to which the broadcast bearer corresponds.

In one example of Step 512, DU sends a second MBS broadcast configuration message to UE.

The second MBS broadcast configuration message includes MBS broadcast configuration to which TMGI-2 corresponds, and the broadcast configuration is sent to UE through an MBS control channel, such as an MCCH channel. The second MBS broadcast configuration message includes TMGI-2 and corresponding MBS control information thereof. The control information includes information such as the identifier of TMGI, the group identifier g-RNTI corresponding to TMGI, the configuration of PDCP, the configuration of RLC, the configuration of DRX, the configuration of adjacent areas, and the configuration of the PTM shared channel. With respect to the scenario of the access network sharing, configurations of different TMGIs may be identical. For example, group identifiers of TMGI-1 and TMGI-2 may be identical, and the information such as the configurations of PDCP, the configurations of RLC, the configurations of DRX, the configurations of the adjacent areas, and the configurations of the PTM shared channels are identical. Alternatively, the group identifiers g-RNTIs are different, but air-interface resources scheduled by the different g-RNTIs are identical.

In one example of Step 513, CU-CP sends a first broadcast service bearer modification request to CU-UP.

CU-CP sends to CU-UP a transport layer address assigned by DU for MBS downlink data reception through the message of step 513.

In one example of Step 514, CU-UP sends a first broadcast service bearer modification response to CU-CP.

CU-UP sends the message of step 514 confirming that the modification request of step 513 is successful.

In one example of Step 515, CU-CP sends a second broadcast service bearer modification request to CU-UP.

This step may be omitted, for example, if only one F1 channel is established between DU and CU-UP for the MBS service, this step is omitted. If only two F1 channels are established between DU and CU-UP for the MBS service, this step is employed to establish a second F1 channel.

In one example of Step 516, CU-UP sends a second broadcast service bearer modification response to CU-CP.

CU-UP sends the message of step 516 confirming that the modification request of step 515 is successful.

As described in step 515, step 516 may also be omitted.

In one example of Step 517, CU-CP sends a first broadcast service start response message to CN1.

CU-CP sends the response message indicating that the MBS bearer and context of the TMGI-1 identifier are successfully established to CN1.

In one example of Step 518, CU-CP sends a second broadcast service start response message to CN2.

CU-CP sends the response message indicating that the MBS bearer and context of the TMGI-2 identifier are successfully established to CN2.

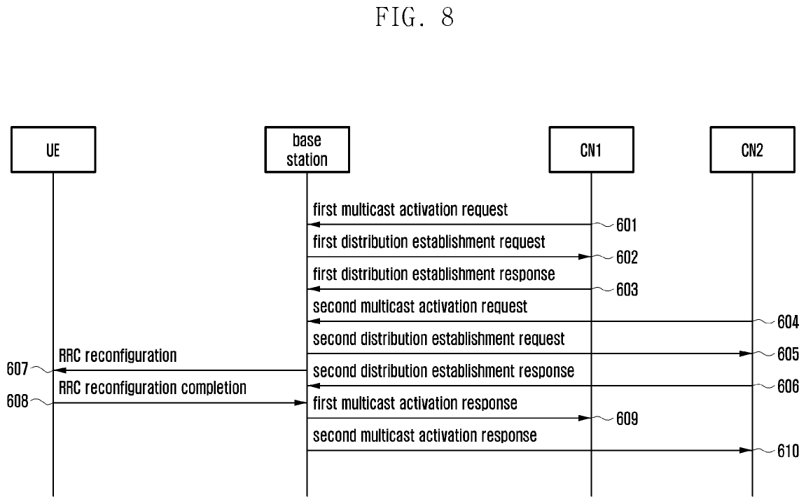

FIG. 8 illustrates an implementing process in which the method according to the embodiment of the present disclosure is applied in an activation process of a multicast service. In this embodiment, the access network is shared by two operators, one MBS service is provided in the networks of the two operators, and MBS identifiers respectively assigned by the two operators to the MBS service are TMGI-1 and TMGI-2.

In one example of Step 601, the base station receives a first multicast service activation request message sent from core network CN1.

The first multicast service activation request message includes a service identifier of MBS, such as TMGI-1. Other information of MBS has been sent to UE context of the base station through previous UE dedicated signaling. The other information of MBS includes the service range of MBS, a transport layer address and/or a channel identifier of the uplink user plane, and the information of MBS quality flow (QoS flow), and these information may be sent to the base station through the UE dedicated signaling.

In one example of Step 602, the base station sends a first multicast distribution establishment request message to CN1.

The message includes an MBS service identifier TMGI-1, and NG-U transport layer address information may be shared.

In one example of Step 603, CN1 sends a first multicast distribution establishment response message to the base station.

The message includes the MBS service identifier TMGI-1, and the NG-U multicast transport layer address information may be shared, and the message includes information of QoS flow of the MBS to be established. The information of QoS flow includes QoS flow ID and quality requirement, and further includes status indication information of the MBS, indicating whether the status of the MBS is activated or inactivated.

In one example of Step 604, the base station receives a second multicast service activation request message sent from core network CN2.

The second multicast service activation request message includes a service identifier of MBS, such as TMGI-2. Other information of MBS has been sent to UE context of the base station through previous UE dedicated signaling. The other information of MBS includes the service range of MBS, a transport layer address and/or a channel identifier of the uplink user plane, and the information of MBS quality flow (QoS flow), and these information may be sent to the base station through the UE dedicated signaling.

In order to save equipment investment of the operator, network sharing is a common deployment method. Network sharing means that the same access network equipment is used by a plurality of operators. An MBS service may be broadcast under the plurality of operators, different operators may assign different service identifiers TMGIs to the same and single MBS service. Currently, the access network identifies different services through TMGIs, once TMGIs are different, it is considered that services are different. The access network assigns different access network resources and air-interface resources to transmit MBS data of actually the same service. In order to reduce resource consumption of the radio network and the air-interface, if one node supports a plurality of operators, the access network may assign the same network resource and air-interface resource for the same and single MBS service to transmit data received from different core networks and belonging to the same and single MBS service. For this purpose, any of the following Method 1 to Method 4 may be employed.

In one embodiment of Method 1, the message further carries an MBS unique service identifier (such as MBS global identity).

The unique service identifier uniquely identifies one MBS service, and MBS services of the same type have the same and single MBS unique service identifier under different operator networks.

In one embodiment of Method 2, the message further carries TMGIs assigned to the MBS by other core networks operating the same and single MBS service.

The same service has a corresponding service identifier TMGI under each operator. For example, in this embodiment, the same service has the service identifier TMGI-1 under operator 1 and the service identifier TMGI-2 under operator 2. When operator 1 sends the MBS service start request message, the message includes not only the service identifier TMGI-1 of the MBS service under operator 1, but also the service identifier TMGI-2 of the same and single MBS service under operator 2. TMGI-2 and TMGI-1 are associated, and point to the same and single MBS service.

In one embodiment of Method 3, partial fields in TMGI-2 and TMGI-1 identifiers are identical, for example, the MBS identifiers (MBS Service IDs) are identical.

The same service has a corresponding service identifier TMGI under each operator. For example, in this embodiment, the same service has the service identifier TMGI-1 under operator 1 and the service identifier TMGI-2 under operator 2. A TMGI includes two parts of contents, one of which is the operator identifier (including MCC and MNC), and another one is employed to identify the MBS service and may be referred to as MBS Service ID. The same and single MBS Service ID and different operator identifiers may be used for the same service under different operators. The same and single MBS service can be identified by using the same and single MBS Service ID under different operators.

In one embodiment of Method 4, there is no newly added information to the message, through operation administration and maintenance (OAM) of the information pre-configured on the base station, the base station may learn that the aforementioned TMGI-1 and TMGI-2 belong to the same and single MBS service.

In one example of Step 605, the base station sends a second multicast distribution establishment request message to CN2.

The message includes the MBS service identifier TMGI-2, and NG-U transport layer address information may be shared.

In one example of Step 606, CN2 sends a second multicast distribution establishment response message to the base station.

The message includes the MBS service identifier TMGI-2, and NG-U multicast transport layer address information may be shared, and the message includes information of QoS flow of the MBS to be established. The information of QoS flow includes QoS flow ID and quality requirement, and further includes status indication information of the MBS, indicating whether the status of the MBS is activated or inactivated.

In one example of Step 607, the base station sends a RRC reconfiguration request message to UE.

The RRC reconfiguration request message includes the service identifier TMGI of MBS, an identifier of MRB to which the TMGI corresponds, configuration of corresponding PDCP, configuration information of RLC to which MRB corresponds, configuration information of MAC, and configuration information of the physical layer. The RRC reconfiguration request message is sent to each UE, and the RRC reconfiguration request message may carry TMGI-1 or TMGI-2 according to difference in the service operators of UE. In order to support access network sharing, and to reduce wastage of air-interface resource, MRBs corresponding to service identifiers (for example, TMGI-1 and TMGI-2 in this embodiment) of a plurality of MBSs may be identical, and identifiers of corresponding MRBs are identical, the configurations of the MRBs are identical, that is, the corresponding PDCP configurations, RLC configurations, MAC configurations, and physical layer configurations are all identical, group identifiers g-RNTIs may also be identical, the physical layer resource used by them is the same, with the same block of resource, and resources assigned to TMGI-1 and TMGI-2 are scheduled through one group identifier. Alternatively, the group identifiers g-RNTIs are different, but the air-interface resource scheduled by different g-RNTIs may be the same.

In one example of Step 608, UE sends an RRC reconfiguration completion message to the base station.

In one example of Step 609, the base station sends a first multicast service activation response message to CN1.

The base station sends the activation response message indicating that the MBS multicast resource has been activated to CN1.

In one example of Step 610, the base station sends a second multicast service activation response message to CN2.

The base station sends the activation response message indicating that the MBS multicast resource has been activated to CN2.

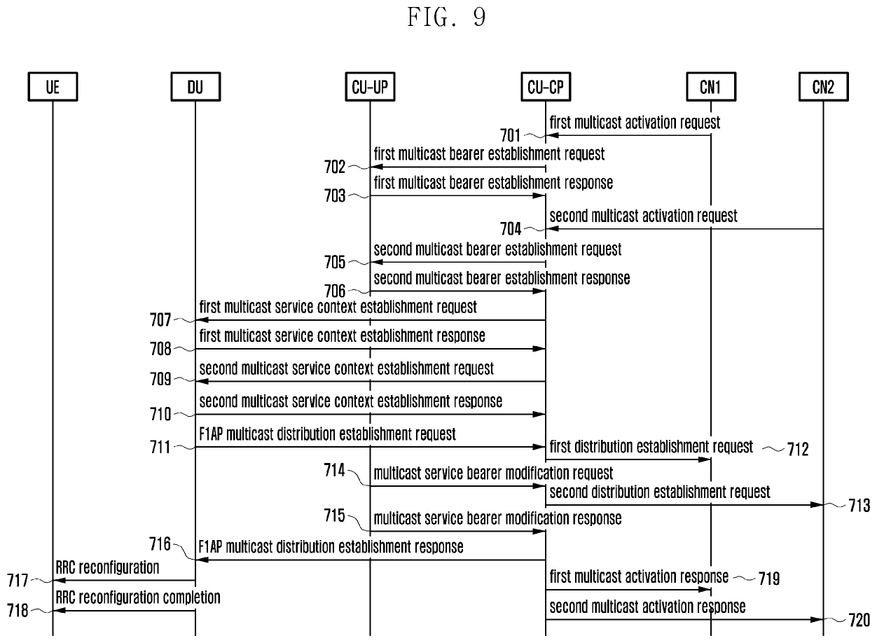

FIG. 9 illustrates an implementing process in which the method according to the embodiment of the present disclosure is applied in an activation process of a multicast service. In this embodiment, the access network is shared by two operators, one MBS service is provided in the networks of the two operators, and MBS service identifiers respectively assigned by the two operators to the MBS service are TMGI-1 and TMGI-2.

In one example of Step 701, CU-CP receives a first multicast service activation request message sent from core network CN1.

Reference may be made to the description in step 601 for contents of the message, for the sake of brevity, no repetition is made here.

In one example of Step 702, CU-CP sends a first multicast bearer establishment request message to CU-UP.

The message includes TMGI-1, and includes an MRB identifier and information of QoS flow, and includes configuration information of PDCP and quality requirement of MRB.

In one example of Step 703, CU-UP sends a first multicast bearer establishment response message to CU-CP.

The message includes the identifier of the successfully established MRB, and a successfully established MBS QoS flow list.

In one example of Step 704, CU-CP receives a second multicast service activation request message sent from CN2.

The core network that belongs to operator 2 sends the second multicast service activation request message to the base station. The second multicast service activation request message includes a service identifier of MBS, such as TMGI-2. Other information of MBS has been sent to UE context of the base station through previous UE dedicated signaling, the other information of MBS includes the service range of MBS, a transport layer address and/or a channel identifier of the uplink user plane, and the information of MBS quality flow (QoS flow), and these information may be sent to the base station through the UE dedicated signaling.

In order to save equipment investment of the operator, network sharing is a common deployment method. Network sharing means that the same access network equipment is used by a plurality of operators. An MBS service may be broadcast under the plurality of operators, different operators may assign different service identifiers TMGIs to the same and single MBS service. Currently, the access network identifies different services through TMGIs, once TMGIs are different, it is then considered that services are different. The access network assigns different access network resources and air-interface resources to transmit MBS data of actually the same service. In order to reduce resource consumption of the radio network and the air-interface, if one node supports a plurality of operators, the access network may assign the same network resource and air-interface resource for the same and single MBS service to transmit data received from different core networks and belonging to the same and single MBS service. For this purpose, any of the following Method 1 to Method 4 may be employed.

In one embodiment of Method 1, the message further carries an MBS unique service identifier (such as MBS global identity).

The unique service identifier uniquely identifies one MBS service, and MBS services of the same type have the same and single MBS unique service identifier under different operator networks.

In one embodiment of Method 2, the message further carries TMGIs assigned to the MBS by other core networks operating the same and single MBS service.

The same service has a corresponding service identifier TMGI under each operator. For example, in this embodiment, the same service has the service identifier TMGI-1 under operator 1 and the service identifier TMGI-2 under operator 2. When operator 1 sends the MBS service start request message, the message includes not only the service identifier TMGI-2 of the MBS service under operator 2, but also the service identifier TMGI-1 of the same and single MBS service under operator 1. TMGI-2 and TMGI-1 are associated, and point to the same and single MBS service.

In one embodiment of Method 3, partial fields in TMGI-2 and TMGI-1 identifiers are identical, for example, the MBS identifiers (MBS service IDs) are identical.

The same service has a corresponding service identifier TMGI under each operator, For example, in this embodiment, the same service has the service identifier TMGI-1 under operator 1 and the service identifier TMGI-2 under operator 2. A TMGI includes two parts of contents, one of which is the operator identifier (including MCC and MNC), and another one is employed to identify the MBS service and may be referred to as MBS Service ID. The same and single MBS Service ID and different operator identifiers may be used for the same service under different operators. The same and single MBS service can be identified by using the same and single MBS Service ID under different operators.

In one embodiment of Method 4, there is no newly added information to the message, through operation administration and maintenance (OAM) of the information pre-configured on the base station, the base station may learn that the aforementioned TMGI-1 and TMGI-2 belong to the same and single MBS service.

In one example of Step 705, CU-CP sends a second multicast bearer establishment request message to CU-UP.

During the process of establishing an interface between CU-CP and CU-UP, namely during the process of establishing a request from E1, CU-CP may obtain identifiers of operators supported by CU-UP, and learn that CU-UP is a node shared by a plurality of operators.

At previous steps, for example, step 701 to step 703, CU-CP has assigned an MRB bearer to the TMGI-1-related MBS service, and the bearer has been established on CU-UP, CU-CP may use this bearer to transmit data of TMGI-2, that is, to assign to TMGI-2 an MRB identifier and configuration information identical with that of TMGI-1, by which time it is not necessary to send the message of step 705. Alternatively, CU-CP assigns to TMGI-2 an MRB identifier identical with that of the bearer of TMGI-1, and sends the message of step 705 to CU-UP. Alternatively, CU-CP assigns to TMGI-2 an MRB identifier different from that of the bearer of TMGI-1, and sends the message of step 705. CU-UP assigns resource, which is at least partially identical with the resource assigned to TMGI-1, to TMGI-2, according to the same MRB identifier or indication information. Specifically,

According to Method 1, CU-CP receives the first multicast service activation request message in step 701. If the message includes an MBS unique service identifier (such as MBS global identity) and the service identifier TMGI-1, CU-CP assigns an MRB identifier to the MBS service, and sends the first multicast bearer establishment request message in step 701 to CU-UP. The message may include TMGI-1, includes MRB identifier and information of QoS flow, includes configuration information of PDCP and quality requirement of MRB, and the message may further include an MBS unique service identifier (such as MBS global identity).

At the later step 704, CU-CP receives the second multicast service activation request message from core network CN2 of operator 2 which includes an MBS unique service identifier (such as MBS global identity). The second multicast service activation request message further includes the service identifier TMGI-2. If the MBS unique service identifiers included in the first multicast bearer establishment request message and the second multicast bearer establishment request message are identical, CU-CP may learn that the MBS services to which the two messages correspond may be the same and single MBS service, and CU-CP assigns the same MRB identifier to TMGI-1 and TMGI-2. CU-CP sends the second multicast bearer establishment request message in step 705 to CU-UP. The message includes TMGI-2, includes the MRB identifier and information of QoS flow, includes configuration information of PDCP and quality requirement of MRB. The message may further include an MBS unique service identifier (such as MBS global identity).

CU-UP receives the first multicast bearer establishment request message and the second multicast bearer establishment request message. If the MRB identifiers included in the two messages are identical, CU-UP may learn that the MBS services to be established by the two messages belong to the same service. If the MRB identifiers included in the two messages are different, and the two messages both include MBS unique service identifiers and the MBS unique service identifiers are identical, CU-UP may learn that the MBS services to be established by the two messages belong to the same service. CU-UP assigns the same resource to TMGI-1 and TMGI-2.

When the second multicast service activation request message is received, it is also possible for CU-CP to learn, through the MBS unique service identifiers included in the first multicast service activation request message and the second multicast service activation request message being identical, that they belong to the same and single MBS service. However. CU-CP has established the multicast bearer for TMGI-1 on CU-UP, it is not necessary for CU-CP to send the second multicast bearer establishment request message in step 705. It is considered by default that the resource configured on CU-UP for TMGI-1 is used for TMGI-2 that is received later.

According to Method 2, CU-CP receives the first multicast service activation request message in step 701 which includes service identifier TMGI-1 of MBS at operator 1 and service identifier TMGI-2 of its associated operator 2, CU-CP may learn that TMGI-1 and TMGI-2 are directed to the same service, CU-CP assigns the MRB identifier to the MBS, and CU-CP sends to CU-UP the first multicast bearer establishment request message in step 702. The message may include TMGI-1, and include the MRB identifier and information of QoS flow. The message may further include the associated TMGI-2.

At the later step 704, CU-CP receives the second multicast service activation request message from core network CN2 of operator 2 which includes TMGI-2 and TMGI-1. CU-CP may send the second multicast bearer establishment request message in step 705 which includes service identifiers TMGI-1 and TMGI-2 of the MBS under operator 1 and operator 2. The MRB identifier included in the second multicast bearer establishment request may be identical with that included in the first multicast bearer establishment request message. Alternatively, CU-CP considers that the bearer of the MBS has been established on CU-UP, and does not send the second broadcast bearer establishment request message in step 705.

According to Method 3, CU-CP receives the first multicast service activation request message in step 701, and the message includes service identifier TMGI-1 of MBS at operator 1. CU-CP sends to CU-UP the first multicast bearer establishment request message instep 702, and the message may include TMGI-1, include the MRG identifier and information of QoS flow.

Thereafter, at step 704, CU-CP receives the second multicast service activation request message sent from core network CN2 which includes TMGI-2. CU-CP may learn, through the identical MBS Service ID included in TMGI-1 and TMGI-2, that TMGI-1 and TMGI-2 actually belong to the same and single MBS service, and CU-CP may assign to TMGI-2 an MRB identifier that is identical with that of TMGI-1 or different from that of TMGI-1. CU-CP sends to CU-UP the second multicast bearer establishment request message in step 705, and the message may include TMGI-2, and include the MRB identifier and information of QoS flow.

CU-UP receives the first multicast bearer establishment request message and the second multicast bearer establishment request message. If the MRB identifiers included in the two messages are identical, CU-UP may learn that the MBS services to be established by the two messages belong to the same service. If the MRB identifiers included in the two messages are different, and TMGI-1 and TMGI-2 included in the two messages have the same and single MBS Service ID, CU-UP may learn that the MBS services to be established by the two messages belong to the same service, and CU-UP assigns the same resource to TMGI-1 and TMGI-2.

According to Method 4, CU-CP receives the first multicast service activation request message instep 701, and the message includes service identifier TMGI-1 of the MBS under operator 1. CU-CP sends to CU-UP the first multicast bearer establishment request message instep 702, and the message may include TMGI-1, and include the MRB identifier and information of QoS flow.

Thereafter, at step 704, CU-CP receives the second multicast service activation request message sent from core network 2 which includes TMGI-2. CU-CP may learn from pre-configuration that TMGI-1 and TMGI-2 are directed to the same service, and CU-CP assigns identical MRB identifiers or different MRB identifiers to TMGI-1 and TMGI-2. The second multicast service bearer establishment request message sent from CU-CP may include TMGI-2, and include the MRB identifier and information of QoS flow.

CU-UP receives the first multicast bearer establishment request message and the second multicast bearer establishment request message. If the MRB identifiers included in the two messages are identical, CU-UP may know that the MBS services to be established by the two messages belong to the same service. If the MRB identifiers included in the two messages are different, as the two messages respectively include TMGI-1 and TMGI-2, CU-UP knows through pre-configuration that TMGI-1 and TMGI-2 are directed to the same service. CU-UP assigns the same resource to TMGI-1 and TMGI-2.

In one example of Step 706, CU-UP sends a second multicast bearer establishment response message to CU-CP.

The message includes an identifier of the successfully established MRB, and a successfully established MBS QoS flow list.

In one example of Step 707, CU-CP sends a first multicast service context establishment request message to DU.

The message includes a service identifier of the MBS, such as TMGI-1, the service range of the MBS, such as identifiers of a group of service areas (such as SAIs), or identifiers of a group of cells (such as CGIs), or identifiers of a group of routing areas (such as TAIs, or TACs). The multicast service context establishment request message further include information of the MBS radio bearer to be established, such as the identifier of MRB, quality requirement of MRB, the identifier of QoS flow mapped to the MRB, and QoS requirement of QoS flow.

Under the scenario of access network sharing, the multicast service context establishment request message may further contain:
an MBS unique service identifier (such as MBS global identity);
TMGI-2, the message may further include TMGI-2 besides TMGI-1, and TMGI-1 and TMGI-2 are associated, and point to the same and single MBS service; and
MRB identifier, with respect to the shared access network, CU-CP assigns the same MRB identifier to TMGI-1 and TMGI-2.

DU receives the message of step 707, and may learn that the same resource and the same RLC or MAC configuration being assigned for the MBS services identified by TMGI-1 and TMGI-2. CU-CP may only send one broadcast service context establishment request message to DU, and does not send the second broadcast service context establishment request message in step 709 to DU.

DU receives the first multicast service context establishment request message in step 707. If the second multicast service context establishment request message in step 709 is thereafter received, it is required for DU to learn from the information included in the two messages that the two messages are directed to the same and single MBS service, and the same resource may therefore be assigned. As described above, it may be known that TMGI-1 and TMGI-2 are directed to the same and single MBS service, through the same and single MBS unique service identifier, such as MBS global identity, or the same MRB identifier included in the first multicast service context establishment request message and the second multicast service context establishment request message, or through the same and single MBS Service ID included in the TMGI-1 and TMGI-2, or through pre-configuration on DU. DU assigns the same resource and the same RLC or MAC configuration, the same physical layer resource, and the same group identifier G-RNGI to the MBS services identified by TMGI-1 and TMGI-2. Alternatively, group identifiers g-RNTIs are different, but the air-interface resource scheduled by different g-RNTIs may be identical.

In one example of Step 708, DU sends a first multicast service context establishment response message to CU-CP.

The message includes the successfully established MRB identifier.

In one example of Step 709, CU-UP sends a second multicast service context establishment request message to DU.

Step 709 may be omitted, that is, multicast service contexts of TMGI-1 and TMGI-2 are established through one piece of multicast service context establishment request message. It is also possible to establish channels of TMGI-1 and TMGI-2 respectively on F1 with two multicast service context establishment request messages.

In one example of Step 710, DU sends a second multicast service context establishment response message to CU-CP.

The message includes the successfully established MRB identifier, and includes F1-U transport layer information to which the multicast bearer corresponds.

In one example of Step 711, DU sends an F1AP multicast distribution establishment request message to CU-CP.

The message includes the MRB identifier, and includes an MRB F1-U transport layer address assigned by DU.

In one example of Step 712, CU-CP sends a first multicast distribution establishment request message to core network CN1.

The message includes the MBS service identifier TMGI-1, and the NG-U transport layer address information may be shared.

In one example of Step 713, CU-CP sends a second multicast distribution establishment request message to core network CN2.

The message includes the MBS identifier TMGI-2, and the NG-U transport layer address information may be shared.

Step 714—CU-CP sends a multicast service bearer modification request to CU-UP.

CU-CP sends to CU-UP the transport layer address assigned by DU for MBS downlink data reception through the message of step 714.

In one example of Step 715, CU-UP sends a multicast service bearer modification response to CU-CP.

CU-UP sends the message of step 715 confirming that the modification request of step 714 is successful. The message may further include a transport layer address of F1-U assigned by CU-UP.

In one example of Step 716, CU-CP sends an F1AP multicast distribution establishment response message to DU.

CU-CP sends the F1AP multicast distribution establishment response message to DU which includes the MRB identifier and F1-U transport layer address information assigned by CU-UP.

In one example of Step 717, the base station sends a RRC reconfiguration request message to UE.

The RRC reconfiguration request message includes the service identifier TMGI of MBS, an identifier of MRB to which the TMGI corresponds, configuration of corresponding PDCP, configuration information of RLC to which MRB corresponds, configuration information of MAC, and configuration information of the physical layer. The RRC reconfiguration request message is sent to each UE, and the RRC reconfiguration request message may carry TMGI-1 or TMGI-2 according to difference in the service operators of UE. In order to support access network sharing, and to reduce wastage of air-interface resource, MRBs corresponding to service identifiers (for example, TMGI-1 and TMGI-2 in this embodiment) of a plurality of MBSs may be identical, and identifiers of corresponding MRBs are identical, the configurations of the MRBs are identical, that is, the corresponding PDCP configurations, RLC configurations, MAC configurations, and physical layer configurations are all identical, group identifiers g-RNTIs may also be identical, the physical layer resource used by them is the same, with the same block of resource, and resources assigned to TMGI-1 and TMGI-2 are scheduled through one group identifier. Alternatively, the group identifiers g-RNTIs are different, but the air-interface resource scheduled by different g-RNTIs may be the same.

In one example of Step 718, UE sends an RRC reconfiguration completion message to DU.

In one example of Step 719, CU-CP sends a first multicast service activation response message to CN1.

CU-CP sends the response message to CN1, the response message includes the MBS identifier TMGI-1, and the response message indicates that the MBS multicast resource has been activated.

In one example of Step 720, CU-CP sends a second multicast service activation response message to CN2.

CU-CP sends the response message to CN2, the response message includes the MBS identifier TMGI-2, and the response message indicates that the MBS multicast resource has been activated.

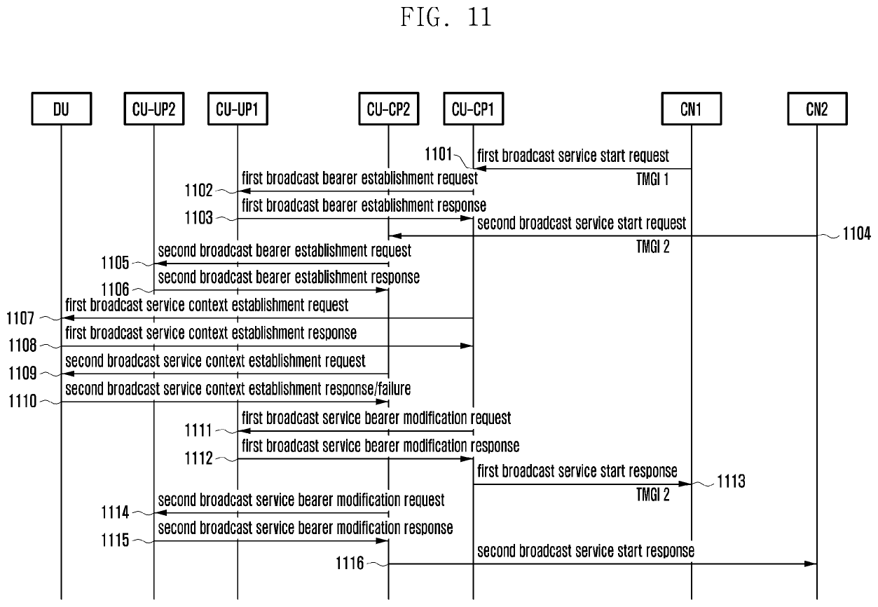

FIG. 11 illustrates an implementing process that the method according an embodiment of the present disclosure is applied in a service start process of a broadcast service, in which the DU of the access network is shared by two operators, CU-CP and CU-UP are not shared, and each operator is deployed with respective CU-CP and CU-UP. One MBS service is supplied in the networks of two operators, and MBS service identifiers assigned by the two operators to the MBS service are respectively TMGI-1 and TMGI-2.

In one example of Step 1101, CU-CP1 receives a first broadcast service start request message sent by core network CN1.

Core network CN1 belonging to operator 1 sends the first broadcast service start request message to CU-CP1. The first broadcast service start request message includes service identifiers of MB S, such as TMGI-1, service range of MB S, such as identifiers of a group of service areas (e.g., SAIs), or identifiers of a group of cells (e.g., CGIs), or identifiers of a group of routing areas (e.g., TAIs, or TACs), transport layer address of uplink user plane and/or channel identifiers. The message further includes information of MBS quality flow (QoS flow) to be established, such as identifiers of QoS flow, and QoS requirement of QoS flow. The message further carries an MBS unique service identifier (e.g., MBS global identity). The unique service identifier uniquely identifies one MBS service, and the MBS unique service identifier is the same under different operator networks with respect to the same and single MBS service. The message may further include TMGI-2, and TMGI-1 is associated with TMGI-2, directing to the same and single MBS service.

In one example of Step 1102, CU-CP1 sends a first broadcast bearer establishment request message to CU-UP1.

During the process of establishing an interface between CU-CP1 and CU-UP1, i.e., during the process of establishing a request from E1, CU-CP1 may obtain identifiers of operators supported by CU-UP1, and learn that CU-UP1 is not shared by a plurality of operators.

The first broadcast bearer establishment request message includes the MBS service identifier TMGI-1, MRB identifier, configuration information of PDCP of MBS, and information of MBS QoS flow. Wherein, information of MBS QoS flow includes identifier of the QoS flow, and quality requirement parameter of the QoS flow.

In one example of Step 1103, CU-UP1 sends a first broadcast bearer establishment response message to CU-CP1.

The first broadcast bearer establishment response message includes an MRB identifier, and information of successfully established QoS flow.

Similarly, CU-CP2 also receives a broadcast service start request sent by core network CN2. The following step 1104, step 1105 and step 1106 are respectively similar to step 1101, step 1102 and step 1103.

In one example of Step 1104, CU-CP2 receives a second broadcast service start request message sent by core network CN2.

Core network CN2 belonging to operator 2 sends the second broadcast service start request message to CU-CP2. The second broadcast service start request message includes service identifiers of MB S, such as TMGI-2, service range of MB S, such as identifiers of a group of service areas (e.g., SAIs), or identifiers of a group of cells (e.g., CGIs), or identifiers of a group of routing areas (e.g., TAIs, or TACs), transport layer address of uplink user plane and/or channel identifiers. The message further includes information of MBS quality flow (QoS flow) to be established, such as identifiers of QoS flow, and QoS requirement of QoS flow. The message further carries an MBS unique service identifier (e.g., MBS global identity). The unique service identifier uniquely identifies one MBS service, and the MBS unique service identifier is the same under different operator networks with respect to the same and single MBS service. The message may further include TMGI-1, and TMGI-1 is associated with TMGI-2, directing to the same and single MBS service.

In one example of Step 1105, CU-CP2 sends a second broadcast bearer establishment request message to CU-UP2.

During the process of establishing an interface between CU-CP2 and CU-UP2, i.e., during the process of establishing a request from E1, CU-CP2 may obtain identifiers of operators supported by CU-UP2, and learn that CU-UP2 is not shared by a plurality of operators.

The second broadcast bearer establishment request message includes the MBS service identifier TMGI-2, MRB identifier, configuration information of PDCP of MBS, and information of MBS QoS flow. Wherein, information of MBS QoS flow includes identifier of the QoS flow, and quality requirement parameter of the QoS flow.

In one example of Step 1106, CU-UP2 sends a second broadcast bearer establishment response message to CU-CP2.

The second broadcast bearer establishment response message includes an MRB identifier, and information of successfully established QoS flow.

In one example of Step 1107, CU-CP1 sends a first broadcast service context establishment request message to DU.

During the process of establishing an interface between CU-CP1 and DU, i.e., during the process of establishing a request from F1, CU-CP1 may obtain identifiers of operators supported by DU, and learn that DU is shared by a plurality of operators.

The message includes service identifiers of MBS, such as TMGI-1, service range of MBS, such as identifiers of a group of service areas (e.g., SAIs), or identifiers of a group of cells (e.g., CGIs), or identifiers of a group of routing areas (e.g., TAIs, or TACs), and the message further includes MBS CU to DU RRC information. The MBS CU to DU RRC information includes a cell list of MBS broadcast and a list of adjacent cells broadcasting the MBS service, and the MBS CU to DU RRC information further includes MRB PDCP configuration. The first broadcast service context establishment request message further includes information of MBS radio bearer to be established, such as identifier of MRB, quality requirement of MRB, identifier of QoS flow mapped to the MRB, and QoS requirement of the QoS flow. The broadcast is carried therewith the transport layer address of CU or CU-UP.

The message further includes an MBS unique service identifier (such as MBS global identity), and TMGI-1, besides which the message may further include TMGI-2, TMGI-1 is associated with TMGI-2, directing to the same and single MBS service.

In one example of Step 1108, DU sends a first broadcast service context establishment response or failure message to CU-CP1.

DU receives the message of step 1107, and it is required for DU to establish a user plane between CU-UP1, for the transmission of MBS data. DU assigns address TNL of the user plane, and sends the first broadcast service context establishment response message to CU-CP1. The message includes the address TNL of the user plane assigned by DU.

In one example of Step 1109, CU-CP2 sends a second broadcast service context establishment request message to DU.

The message includes service identifiers of MBS, such as TMGI-1, service range of MBS, such as identifiers of a group of service areas (e.g., SATs), or identifiers of a group of cells (e.g., CGIs), or identifiers of a group of routing areas (e.g., TAIs, or TACs), and the message includes MBS CU to DU RRC information. The MBS CU to DU RRC information includes a cell list of MBS broadcast and a list of adjacent cells broadcasting the MBS service, and the MBS CU to DU RRC information further includes MRB PDCP configuration. The second broadcast service context establishment request message further includes information of MBS radio bearer to be established, such as identifier of MRB, quality requirement of MRB, identifier of QoS flow mapped to the MRB, and QoS requirement of QoS flow. The broadcast is carried therewith the transport layer address of CU-UP2. The message further includes an MBS unique service identifier (such as MBS global identity). The message may further include TMGI-1 besides TMGI-2, TMGI-1 is associated with TMGI-2, directing to the same and single MBS service.

DU receives the second broadcast service context establishment request message, and learns from information carried in the message that the data of the same and single MBS service is transmitted through the user plane established between CU-UP1. DU may decide whether to establish a user plane for user to transmit an MBS service with CU-UP2.

In one example of Step 1110, DU sends a second broadcast service context establishment response or failure message to CU-CP2.

DU is shared by two operators, and is connected respectively to CU-CP1, CU-UP1, CU-CP2, and CU-UP2. Wherein, CU-CP1 and CU-UP1 belong to the first operator, and CU-CP2 and CU-UP2 belong to the second operator. DU decides to establish the number of user planes for transmission of MBS data, whether to establish user planes for transmission of MBS data with both CU-UP1 and CU-UP2, or whether to establish a user plane for transmission of MBS data with only one of them.

If there are not only shared cells but also unshared cells on DU, it is required for DU to establish user plane connection between CU-UP2, so as to facilitate the transmission of MBS data. DU sends the broadcast service context establishment response message, and the response message includes the transport layer address (TNL) of the user plane assigned by DU. A shared cell on DU may receive data from the channel between DU and CU-UP1, and may also receive data from the channel between DU and CU-UP2, the data received from the two channels is directed to the data of the same and single MBS service, the content transmitted is the same, while only one piece of MBS data is sent on the air interface of the cell.

Accordingly, it is required for DU to select the data on one of the two channels from the data transmitted on the two channels as received, and to send the same on the air interface, that is, to select the data transmitted by one of the user planes for transmission on the air interface. For example, it is possible to select the data transmitted on the firstly established channel, in this embodiment, the data transmitted on the channel between DU and CU-UP1 is selected. In the MBS control information transmitted on the air interface, configuration information of PDCP to which the MBS wireless channel MRB corresponds may be broadcast, configurations of PDCPs assigned by CU-CP1 and CU-CP2 may be different, according to the user plane selected by DU above, DU also selects the PDCP to which this user plane corresponds, and DU broadcasts the configuration information of the PDCP on the air interface of the shared cell.

If cells on DU are all shared, and DU has established a user plane for receiving MBS data between CU-UP1, DU may receive MBS data from CU-UP1, therefore, DU may not establish a user plane for receiving MBS data between CU-UP2. DU may send the broadcast service context establishment response message or broadcast service context establishment failure message, the message carries therewith indication information indicating that DU is shared, a user plane for receiving MBS data has already been established on DU, and it is not required to establish a user plane for receiving MBS data between CU-UP2. CU-CP2 receives the message and sends a broadcast bearer alteration request message to CU-UP2, requesting to delete information related to MBS already established on CU-UP2. Further, CU-UP2 may send a broadcast service start response message or a broadcast service start failure message to CN2, the message includes a service identifier of MBS, and further includes indication information indicating that the access network is a shared network, a user plane for receiving MBS data has already been established, and it is not required to establish a user plane for receiving MBS data between CN2. CN2 receives the indication information, it is then not required to send message to the user function entity of MBS, and it is not required for the core network to establish a user plane for the user to transmit MBS data.

Alternatively, DU decides to establish a user plane for receiving MBS data between DU and CU-UP2, DU may send a broadcast service context establishment response message carrying existing configuration information of PDCP to which the user plane for receiving MBS data corresponds. CU-CP2 receives the configuration information of the PDCP, and configuration of PDCP of CU-UP2 may be modified, thus, PDCP configurations used by CU-UP1 and CU-UP2 are identical.

In one example of Step 1111, CU-CP1 sends a first broadcast service bearer modification request to CU-UP1.

The message includes an MRB identifier, includes a transport layer address of the user plane assigned by DU, and may further include configuration information of PDCP.

In one example of Step 1112, CU-UP1 sends a first broadcast service bearer modification response message to CU-CP1.

The message includes the successfully established MRB identifier.

In one example of Step 1113, CU-CP1 sends a first broadcast service establishment response message to CN1.

The message includes the MRB identifier TMGI, and further includes the transport layer address assigned by CU-UP1.

In one example of Step 1114, CU-CP2 sends a second broadcast service bearer modification request message to CU-UP2.

If the message of step 1110 is received, the message carries indication information indicating sharing of DU, DU has already established the user plane for receiving MBS data, and it is not required to establish a user plane for receiving MBS data between CU-UP2, then CU-CP2 sends the bearer modification request message, and the message includes the MRB identifier to be deleted.

In one example of Step 1115, CU-UP2 sends a second broadcast service bearer modification response to CU=CP2.

The message includes the successfully modified MRB identifier.

In one example of Step 1116, CU-CP2 sends a second broadcast service broadcast service establishment response message or broadcast service establishment failure message to CN2.

The message includes the MRB identifier TMGI, and further includes the transport layer address assigned by CU-UP.

If the message of step 1110 is received, the message carries indication information indicating sharing of DU, DU has already established the user plane for receiving MBS data, and it is not required to establish a user plane for receiving MBS data between CU-UP2, and CU-CP2 may send the broadcast service establishment response message or broadcast service establishment failure message to CN2, the message may further indicate the reason why the user plane is not established is that the RAN side is shared, RAN has already established a user plane of the MBS service, and it is not required to establish a user plane for receiving MBS data between CN2. CN2 receives the indication information, and it is not required to send the message to the user function entity of MBS, and it is not required for the core network to establish a user plane of the user for transmission of MBS data.

An embodiment of the present disclosure provides an electronic device, including: a transceiver for transmitting and receiving signals; and a processor, coupled with the transceiver and configured to control to implement the steps of the aforementioned method embodiments.

Optionally, the electronic device may be a first node, and the processor in the electronic device is configured to control to implement the steps of the methods performed by the first node according to the aforementioned method embodiments.

In this embodiment, the first node may be a distributed unit DU, or CU-UP, or CU-CP, or a base station.

Optionally, the electronic device may be a second node, and the processor in the electronic device is configured to control to implement the steps of the methods performed by the second node according to the aforementioned various method embodiments.

In this embodiment, the second node may be CU-CP or a core network entity.

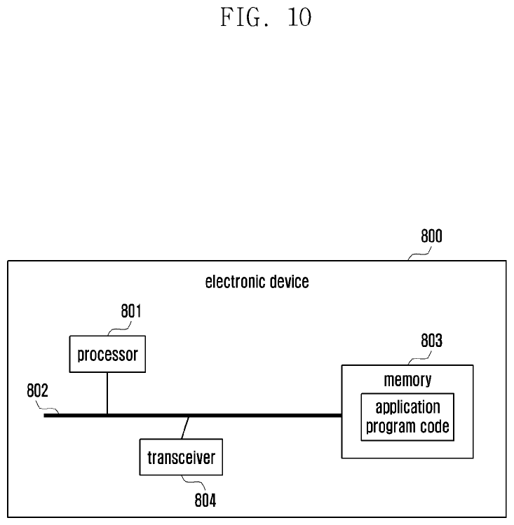

There is provided an electronic device in an optional embodiment, as shown in FIG. 10, the electronic device 800 shown in FIG. 10 may include a processor 801 and a memory 803. The processor 801 is connected to the memory 803, for example, through a bus 802. Optionally, the electronic device 800 may further include a transceiver 804 which may be used for data interaction between the electronic device and other electronic devices, such as data transmission and/or data reception. It should be noted that, in practical applications, the transceiver 804 is not limited to one, and the structure of the electronic device 800 does not constitute any limitations to the embodiments of the present disclosure.

The processor 801 may be a central processing unit (CPU), a general-purpose processor, a digital signal processor (DSP), an application specific integrated circuit (ASIC), or a field programmable gate array (FPGA), or other programmable logic devices, transistor logic devices, hardware components, or any combination thereof. It may implement or execute various exemplary logical blocks, modules and circuits described in connection with the present disclosure. The processor 801 may also be a combination for realizing computing functions, for example, a combination of one or more microprocessors, a combination of a DSP and a microprocessor, etc.

The bus 802 may include a path to transfer information between the components described above. The bus 802 may be a peripheral component interconnect (PCI) bus, or an extended industry standard architecture (EISA) bus, etc. The bus 802 may be an address bus, a data bus, a control bus, etc. For ease of presentation, the bus is represented by only one thick line in FIG. 10. However, it does not mean that there is only one bus or one type of buses.

The memory 803 may be, but not limited to, read only memories (ROMs) or other types of static storage devices that can store static information and instructions, random access memories (RAMs) or other types of dynamic storage devices that can store information and instructions, may be electrically erasable programmable read only memories (EEPROMs), compact disc read only memories (CD-ROMs) or other optical disk storages, optical disc storages (including compact discs, laser discs, discs, digital versatile discs, blue-ray discs, etc.), magnetic storage media or other magnetic storage devices, or any other media that can carry or store desired program codes in the form of instructions or data structures and that can be accessed by computers.

The memory 803 is used to store application program codes for executing the solutions of the present disclosure, and is controlled by the processor 801. The processor 801 is used to execute the application program codes stored in the memory 803 to implement the solution provided in any method embodiment described above.

An embodiment of the present disclosure further provides a first node in a wireless communication system, including: a transceiver; and a controller, coupled with the transceiver and configured to perform the steps of the method embodiments performed by the first node.

In this embodiment, the first node may be a distributed unit DU, or CU-UP, or CU-CP, or a base station.

An embodiment of the present disclosure further provides a second node in a wireless communication system, including: a transceiver; and a controller, coupled with the transceiver and configured to perform the steps of the method embodiments performed by the second node.

In this embodiment, the second node may be CU-CP or a core network entity.

Embodiments of the present disclosure provide a computer-readable storage medium having a computer program stored on the computer-readable storage medium, the computer program, when executed by a processor, implements the steps and corresponding contents of the foregoing method embodiments.

Embodiments of the present disclosure also provide a computer program product including a computer program, the computer program when executed by a processor realizing the steps and corresponding contents of the preceding method embodiments.

The terms “first,” “second,” “third,” “fourth,” “1,” “2,” etc. (if present) in the specification and claims of this disclosure and the accompanying drawings above are used to distinguish similar objects and need not be used to describe a particular order or sequence. It should be understood that the data so used is interchangeable where appropriate so that embodiments of the present disclosure described herein can be implemented in an order other than that illustrated or described in the text.

It should be understood that while the flow diagrams of embodiments of the present disclosure indicate the individual operational steps by arrows, the order in which these steps are performed is not limited to the order indicated by the arrows. Unless explicitly stated herein, in some implementation scenarios of embodiments of the present disclosure, the implementation steps in the respective flowcharts may be performed in other orders as desired. In addition, some, or all of the steps in each flowchart may include multiple sub-steps or multiple phases based on the actual implementation scenario. Some or all of these sub-steps or stages can be executed at the same moment, and each of these sub-steps or stages can also be executed at different moments separately. The order of execution of these sub-steps or stages can be flexibly configured according to requirements in different scenarios of execution time, and the embodiments of the present disclosure are not limited thereto.

The above describes is only the preferred embodiments of the present disclosure, and is not used to restrict the present disclosure. Any amendment, equivalent substitution, and improvement, etc. made within the spirit and principle of the present disclosure should be included in the protection scope of the present disclosure.

Although the present disclosure has been illustrated and described with reference to the various embodiments of the present disclosure, as shall be understood by those skilled in the art, various modifications may be made thereto both in form and in detail without departing from the spirit and scope of the present disclosure as defined by the attached Claims and equivalents thereof.

Although the present disclosure has been described with various embodiments, various changes and modifications may be suggested to one skilled in the art. It is intended that the present disclosure encompass such changes and modifications as fall within the scope of the appended claims.

What is claimed is:

1. A method performed by a first node in a communication system, the method comprising:
receiving, from a second node, a request message related to a multicast and broadcast service (MBS), wherein the request message includes at least one of a second temporary mobile packet identifier (TMGI) or indication information; and
transmitting, to the second node, a response message corresponding to the request message,
wherein the indication information includes at least one of an MBS unique identifier or a first TMGI.

2. The method according to claim 1, wherein, based on bearer of an MBS service corresponding to the first TMGI being established:
bearer of an MBS service corresponding to the second TMGI is not established, and
the response message indicates that the bearer of the MBS service corresponding to the second TMGI is not established based on information that the first node is shared.

3. The method according to claim 1, wherein the response message includes configuration information of a packet date convergence protocol (PDCP) used on the first node.

4. The method according to claim 1, wherein:
the first node is at least one of a distributed unit (DU), a central unit-control plane (CU-CP), a central unit-user plane (CU-UP), or a base station; and
the second node is at least one of the CU-CP or a core network entity.

5. A method performed by a second node in a communication system, the method comprising:
transmitting, to a first node, a request message related to a multicast and broadcast service (MBS), wherein the request message includes at least one of a second temporary mobile packet identifier (TMGI) or indication information; and
receiving, from the first node, a response message corresponding to the request message,
wherein the indication information includes at least one of an MBS unique identifier or a first TMGI.

6. The method according to claim 5, wherein, based on bearer of an MBS service corresponding to the first TMGI being established:
bearer of an MBS service corresponding to the second TMGI is not established; and
the response message indicates that the bearer of the MBS service corresponding to the second TMGI is not established based on information that the first node is shared.

7. The method according to claim 5, wherein the response message includes configuration information of a packet data convergence protocol (PDCP) used on the first node.

8. The method according to claim 5, wherein:
the first node is at least one of a distributed unit (DU), a central unit-control plane (CU-CP), a central unit-user plane (CU-UP), or a base station; and
the second node is at least one of the CU-CP or a core network entity.

9. A first node in a communication system, the first node comprising:
a transceiver; and
a processor coupled with the transceiver and configured to:
receive, from a second node, a request message related to a multicast and broadcast service (MBS), wherein the request message includes at least one of a second from a second node (TMGI) or indication information, and
transmit, to the second node, a response message corresponding to the request message,
wherein the indication information includes at least one of an MBS unique identifier or a first TMGI.

10. The first node according to claim 9, wherein based on bearer of an MBS service corresponding to the first TMGI being established:
bearer of an MBS service corresponding to the second TMGI is not established; and
the response message indicates that the bearer of the MBS service corresponding to the second TMGI is not established based on information that the first node is shared.

11. The first node according to claim 9, wherein the response message includes configuration information of a packet date convergence protocol (PDCP) used on the first node.

12. The first node according to claim 9, wherein:
the first node is at least one of a distributed unit (DU), a central unit-control plane (CU-CP), a central unit-user plane (CU-UP), or a base station; and
the second node is at least one of the CU-CP or a core network entity.

13. A second node in a communication system, the second node comprising:
a transceiver; and
a processor coupled with the transceiver and configured to:
transmit, to a first node, a request message related to a multicast and broadcast service (MBS), wherein the request message includes at least one of a second temporary mobile packet identifier (TMGI) or indication information, and
receive, from the first node, a response message corresponding to the request message,
wherein the indication information includes at least one of an MBS unique identifier or a first TMGI.

14. The second node according to claim 13, wherein based on bearer of an MBS service corresponding to the first TMGI being established:
bearer of an MBS service corresponding to the second TMGI is not established; and
the response message indicates that the bearer of the MBS service corresponding to the second TMGI is not established based on information that the first node is shared.

15. The second node according to claim 13, wherein the response message includes configuration information of a packet data convergence protocol (PDCP) used on the first node.

16. The second node according to claim 13, wherein:
the first node is at least one of a distributed unit (DU), a central unit-control plane (CU-CP), a central unit-user plane (CU-UP), or a base station; and
the second node is at least one of the CU-CP or a core network entity.
